(19) United States
(12) Patent Application Publication
(10) Pub. No.: US 2026/0094852 A1
(43) Pub. Date: Apr. 2, 2026

(54) SOLID-STATE ELECTROLYTE SHEET, SOLID OXIDE FUEL CELL, SOLID OXIDE ELECTROLYZER CELL, AND METHODS OF MAKING THE SAME

(71) Applicant: CORNING INCORPORATED, CORNING, NY (US)

(72) Inventors: Shyam Lekhraj Chatlani, Big Flats, NY (US); Rahul Suryakant Kadam, Big Flats, NY (US); Timothy Joseph Markel, Painted Post, NY (US); Nathan Michael Zink, Painted Post, NY (US)

(21) Appl. No.: 19/338,303

(22) Filed: Sep. 24, 2025

Related U.S. Application Data
(60) Provisional application No. 63/701,821, filed on Oct. 1, 2024.

(51) Int. Cl. H01M 8/1253

(52) U.S. Cl. CPC H01M 8/1253

(57) ABSTRACT

A solid-state electrolyte sheet includes stabilized zirconia grains having from 3 mol % to 12 mol % of a dopant selected from alumina, cerium oxide, gadolinium oxide, scandia, yttria, ytterbia, and combinations thereof. In aspects, the solid-state electrolyte sheet exhibits an ionic conductivity of 6.79 S/m or more at 800° C. or 8.8 S/m or more at 835° C. In aspects, the stabilized zirconia grains can exhibit a ratio of a cubic phase to a tetragonal phase (C/T ratio) of 0.12 or more. In aspects, the solid-state electrolyte sheet can be part of a solid oxide fuel cell and/or a solid oxide electrolyzer cell. Methods include casting a green tape comprising stabilized zirconia and firing the green tape by heating to form a sintered tape and then quenching the sintered tape from a starting temperature of 600° C. or more to a final temperature of less than 100° C.

### CROSS-REFERENCE TO RELATED APPLICATIONS

This application claims the benefit of priority under 35 U.S.C. § 119 of U.S. Provisional Application Ser. No. 63/701,821 filed on Oct. 1, 2024, the content of which is relied upon and incorporated herein by reference in its entirety.

### TECHNICAL FIELD

The present disclosure relates to solid-state electrolyte sheets, solid oxide fuel cells, solid oxide electrolyzer cells, and methods of making the same, and more particularly, to a solid-state electrolyte sheet comprising stabilized zirconia, solid oxide fuel cells including the same, solid oxide electrolyzer cells including the same, and methods of making the same.

### BACKGROUND

Fossil fuels have long been a primary source of energy. However, fossil fuels are finite and, when burned to produce heat, produce a suboptimal amount of air pollution and greenhouse gases. To reduce reliance on fossil fuels as an energy source, renewable energy sources such as solar energy and wind energy are being used to generate electrical energy. The generation of electrical energy spurs demand for devices that store the electrical energy that renewable energy sources (and fossil fuels too) generate in the form of chemical energy.

One chemical storage method is an electrolyzer cell, where electrical energy is converted into chemical energy (e.g., by splitting water). The chemical energy can later be harvested using a fuel cell that reverses the reaction of the electrolyzer cell. There are a variety of electrolyzer cells and fuel cells that have been developed, each employing different types of electrolyte materials (e.g., perfluorosulfonic acid (PFSA) polymers) to facilitate ion transport therethrough while avoiding a short circuit in the cell. However, PFSA electrolytes have a limited operating temperature. Consequently, there is a need for solid-state, non-polymeric electrolyte materials that exhibit high ionic conductivity and can operate a temperatures of 700° C. or more.

### SUMMARY

The present disclosure provides a solid-state electrolyte sheet, solid-oxide fuel cell, solid oxide electrolyzer cell, and methods of making the same. The solid-state electrolyte sheet can achieve high ionic conductivity (e.g., 6.7 S/m or more at 800° C., 8.8 S/m at 835° C., 9.5 S/m or more at 850° C., 13.0 S/m or more at 900° C., or 18.0 S/m or more at 950° C.) formed as a result of the methods of the present disclosure. Examples 1-26 demonstrate an unexpected benefit of increased ionic conductivity beyond that reported in the prior art under similar conditions. Without wishing to be bound by theory, it is believed that the phase assemblage (C/T ratio), closed porosity, small average grain size, small maximum grain size, and/or low porosity contribute to the unexpectedly high ionic conductivity. Without wishing to be bound by theory, it is believed that providing a low average grain size (e.g., from 0.1 μm to 2.5 μm or from 0.1 μm to 1.5 μm) can increase the ionic conductivity, for example, by decreasing a path length along grain boundaries that could be travelled by ion transported through the solid-state electrolyte sheet. Without wishing to be bound by theory, it is believed that by limiting a maximum grain size, the ionic conductivity can be increased, for example, by decreasing a path length along grain boundaries that could be travelled by ion transported through the solid-state electrolyte sheet and/or by providing additional grain boundary per volume of the solid-state electrolyte. Providing a majority of pores as closed pores can enable an increased ionic conductivity. Also, providing a majority of pores as closed pores can facilitate longevity of the resulting solid oxide fuel cell and/or solid oxide electrolyzer cell, for example, by reducing an incidence of short circuiting the cell through the solid state electrolyte sheet (e.g., in the case of an open pore providing a path from the first major surface to the second major surface).

Further, methods of the present disclosure heat then quench to kinetically trap (e.g., “freeze in”) a phase assemblage. As discussed herein, the inventors unexpectedly discovered that quenching (e.g., from a temperature of 500° C. or more, from a temperature in a range from 600° C. to 1000° C.) can impact the resulting crystal structure(s) of the resulting solid-state electrolyte sheet and provide unexpectedly improved ionic conductivity. Consequently, it has been unexpectedly observed that increasing the amount of cubic phase in the stabilized zirconia grains can increase ionic conductivity. Without wishing to be bound by theory, it is believed that quenching from at least 500° C. can increase an amount of a cubic phase in the stabilized zirconia grains of the solid-state electrolyte sheet. The present inventors believe that it has not been appreciated that that the phase structure at a high temperatures can be largely maintained (e.g., “locked in”) by quenching from the high temperature to a temperature near room temperature (e.g., less than 100° C., from 0° C. to 40° C.).

Methods of the present disclosure can enable the formation of long ribbons of the solid-state electrolyte sheet. Firing a green tape to form the solid-state electrolyte sheet can comprise a single firing step or a plurality of firing steps. The one or more firing steps can comprise heating at a maximum temperature of 1650° C. or less (or 1625° C. or less or 1600° C. or less), which can facilitate formation of the microstructure (e.g., grain size, porosity, and/or associated grain size distribution) associated with the increased ionic conductivity of the solid-state electrolyte sheets of the present disclosure. Heating the green tape (at temperatures of 600° C. or more) for 90 minutes or less (e.g., from 5 minutes to 60 minutes) can reduce resource requirements and/or increase a throughput of the method. Also, a maximum period of time at the maximum temperature of from 10 seconds to 20 minutes or from 5% to 20% of the period of time in the firing step at temperatures of 600° C. or more can reduce resource requirements (e.g., energy) of the method. Further, the methods of the present disclosure can achieve stabilized zirconia having substantial portions of grains in the cubic phase (e.g., corresponding to point 1226 in the t+c region 1213) since the cubic phase is kinetically trapped. As demonstrated by the examples here, quenching the sintered tapes (after the heating of the green tape) as part of the firing process unexpectedly increases the presence of the cubic phase (i.e., increases the C/T ratio to greater than or equal 0.10) and unexpectedly increases the ionic conductivity of resulting solid-state electrolyte sheet.

Some example aspects of the disclosure are described below with the understanding that any of the features of the various aspects may be used alone or in combination with one another.

Aspect 1. A solid-state electrolyte sheet comprising:
stabilized zirconia grains comprising from 3 mol % to 12 mol % of a dopant selected from a group consisting of alumina, cerium oxide, gadolinium oxide, scandia, yttria, ytterbia, and combinations thereof;
a thickness in a range from 10 micrometers to 300 micrometers; and
an ionic conductivity at 800° C. of 6.79 S/m or more.

Aspect 2. A solid-state electrolyte sheet comprising:
stabilized zirconia grains comprising from 3 mol % to 12 mol % of a dopant selected from a group consisting of alumina, cerium oxide, gadolinium oxide, scandia, yttria, ytterbia, and combinations thereof;
a thickness in a range from 10 micrometers to 300 micrometers; and
an ionic conductivity at 835° C. of 8.8 S/m or more.

Aspect 3. The solid-state electrolyte sheet of any one of aspects 1-2, wherein the stabilized zirconia grains comprise a mixture of a cubic phase and a tetragonal phase.

Aspect 4. The solid-state electrolyte sheet of any one of aspects 1-2, wherein the stabilized zirconia grains exhibit a ratio of a cubic phase to a tetragonal phase (C/T ratio) of 0.12 or more.

Aspect 5. A solid-state electrolyte sheet comprising:
stabilized zirconia grains comprising from 3 mol % to 12 mol % of a dopant selected from a group consisting of alumina, cerium oxide, gadolinium oxide, scandia, yttria, ytterbia, and combinations thereof;
a thickness in a range from 10 micrometers to 300 micrometers;
an ionic conductivity at 800° C. of 6.79 S/m or more; and
an ionic conductivity at 835° C. of 8.8 S/m or more,
wherein the stabilized zirconia grains exhibit a ratio of a cubic phase to a tetragonal phase (C/T ratio) from 0.15 to 0.50.

Aspect 6. The solid-state electrolyte sheet of any one of aspects 4-5, wherein the C/T ratio is from 0.27 to 0.50.

Aspect 7. The solid-state electrolyte sheet of any one of aspects 1-6, wherein the ionic conductivity at 800° C. is 7.00 S/m or more.

Aspect 8. The solid-state electrolyte sheet of any one of aspects 1-7, wherein the ionic conductivity at 835° C. is 9.0 S/m or more.

Aspect 9. The solid-state electrolyte sheet of any one of aspects 1-8, wherein the thickness is from 20 micrometers to 50 micrometers.

Aspect 10. The solid-state electrolyte sheet of any one of aspects 1-9, wherein a majority of pores in the solid-state electrolyte sheet is a closed porosity.

Aspect 11. The solid-state electrolyte sheet of any one of aspects 1-10, wherein the stabilized zirconia grains comprise from 3 mol % to about 6 mol % of the dopant.

Aspect 12. The solid-state electrolyte sheet of any one of aspects 1-11, wherein the dopant comprises scandia.

Aspect 13. The solid-state electrolyte sheet of aspect 12, wherein the stabilized zirconia grains comprise about 6 mol % scandia.

Aspect 14. The solid-state electrolyte sheet of any one of aspects 12-13, wherein the stabilized zirconia grains are free of at least one of alumina, yttria, a lanthanoid oxide, or combinations thereof.

Aspect 15. The solid-state electrolyte sheet of any one of aspects 1-14, wherein the solid-state electrolyte sheet comprises a porosity of 1.0% or less.

Aspect 16. The solid-state electrolyte sheet of any one of aspects 1-15, wherein an average grain size of the stabilized zirconia grains is from 0.3 μm to 2.5 μm.

Aspect 17. The solid-state electrolyte sheet of any one of aspects 1-15, wherein an average grain size of the stabilized zirconia grains is from 1.01 μm to 2.5 μm.

Aspect 18. The solid-state electrolyte sheet of any one of aspects 1-17, wherein a maximum grain size of the stabilized zirconia grains is less than 5 μm.

Aspect 19. A solid oxide fuel cell comprising:
the solid-state electrolyte sheet of any one of aspects 1-18 comprising a first major surface and a second major surface with the thickness defined therebetween;
an oxygen electrode disposed on the first major surface; and
a fuel electrode disposed on the second major surface.

Aspect 20. The solid oxide fuel cell of aspect 19, wherein the oxygen electrode comprises at least one of iron, manganese, gadolinium, or combinations thereof.

Aspect 21. The solid oxide fuel cell of any one of aspects 19-20, wherein the fuel electrode comprises at least one of nickel, manganese, chromium, scandium, or combinations thereof.

Aspect 22. A solid oxide electrolyzer cell comprising:
the solid-state electrolyte sheet of any one of aspects 1-18 comprising a first major surface and a second major surface with the thickness defined therebetween;
an oxygen electrode disposed on the first major surface; and
a fuel electrode disposed on the second major surface.

Aspect 23. The solid oxide electrolyzer cell of aspect 22, wherein the oxygen electrode comprises at least one of iron, manganese, or combinations thereof.

Aspect 24. The solid oxide electrolyzer cell of any one of aspects 22-23, wherein the fuel electrode comprises at least one of nickel, manganese, chromium, scandium, or combinations thereof.

Aspect 25. A method of making a solid-state electrolyte sheet comprising:
casting a green tape comprising stabilized zirconia comprising from 3 mol % to 12 mol % of a dopant selected from a group consisting of alumina, cerium oxide, gadolinium oxide, scandia, yttria, ytterbia, and combinations thereof;
firing the green tape to form the solid-state electrolyte sheet, wherein the firing comprises:
heating the green tape at temperatures of 600° C. or more for 90 minutes or less with a maximum temperature of 1650° C. or less to form a sintered tape; and
quenching the sintered tape from a temperature of from a starting temperature of 500° C. or more to final temperature of less than 100° C.

Aspect 26. The method of aspect 25, wherein the starting temperature for the quenching is from 600° C. to 1000° C.

Aspect 27. The method of any one of aspects 25-26, wherein the final temperature for the quenching is from 0° C. to 40° C.

Aspect 28. The method of any one of aspects 25-27, wherein the firing comprises the heating at temperatures of 600° C. or more for from 5 minutes to 60 minutes.

Aspect 29. The method of any one of aspects 25-27, wherein the heating comprises heating the green tape at temperatures from greater than or equal to 1300° C. to less than or equal to 1700° C. for from 5 minutes to 60 minutes.

Aspect 30. The method of any one of aspects 25-29, wherein the maximum temperature is maintained for a maximum period of time from 10 seconds to 20 minutes as part of a temperature ramp to the maximum temperature.

Aspect 31. The method of any one of aspects 25-30, wherein a maximum period of time at the maximum temperature, as a percentage of a total period of time heating at temperatures of 600° C. or more is from 5% to 20%.

Aspect 32. The method of any one of aspects 25-31, wherein the firing consists of a single firing step to the maximum temperature followed by the quenching.

Aspect 33. The method of any one of aspects 25-31, wherein the firing comprises a plurality of firing steps prior to the quenching.

Aspect 34. The method of any one of aspects 25-33, wherein a thickness of the solid-state electrolyte sheet is in a range from 10 micrometers to 300 micrometers.

Aspect 35. The method of any one of claims 25-34, wherein the solid-state electrolyte sheet comprises stabilized zirconia grains comprise a mixture of a cubic phase and a tetragonal phase.

Aspect 36. The method of any one of aspects 25-34, wherein the stabilized zirconia grains in the solid-state electrolyte sheet exhibit a ratio of a cubic phase to a tetragonal phase (C/T ratio) is 0.12 or more.

Aspect 37. The method of aspect 36, wherein the C/T ratio is from 0.27 to 0.50.

Aspect 38. The method of any one of aspects 25-36, wherein a cubic phase is the predominant crystal phase in the stabilized zirconia grains.

Aspect 39. The method of any one of aspects 25-38, wherein an average grain size of the stabilized zirconia grains is from 0.3 μm to 2.5 μm.

Aspect 40. The method of any one of aspects 25-38, wherein an average grain size of the stabilized zirconia grains is from 1.01 μm to 2.5 μm.

Aspect 41. The method of any one of aspects 25-40, wherein a majority of pores in the solid-state electrolyte sheet is a closed porosity.

Aspect 42. The method of any one of aspects 25-41, wherein the solid-state electrolyte sheet comprises a porosity of 1% or less.

Aspect 43. The method of any one of aspects 25-42, wherein a maximum grain size of the stabilized zirconia grains is less than 5 μm.

Aspect 44. The method of any one of aspects 25-43, wherein a distribution of grain size of the stabilized zirconia grains is contained between 0.1 μm and 3 μm.

Aspect 45. The method of any one of aspects 25-44, wherein the stabilized zirconia grains comprise from 3 mol % to about 6 mol % of the dopant.

Aspect 46. The method of any one of aspects 25-45, wherein the dopant comprises scandia.

Aspect 47. The method of aspect 46, wherein the scandia-stabilized zirconia grains comprise about 6 mol % scandia.

Aspect 48. The method of any one of aspects 46-47, wherein the stabilized zirconia grains are free of at least one of alumina, yttria, a lanthanoid oxide, or combinations thereof.

Aspect 49. The method of any one of aspects 25-48, wherein the solid-state electrolyte sheet comprises an ionic conductivity at 800° C. is 7.00 S/m or more.

Aspect 50. The method of any one of aspects 25-49, wherein the solid-state electrolyte sheet comprises an ionic conductivity at 835° C. is 9.0 S/m or more.

Aspect 51. The method of any one of aspects 25-50, wherein the solid-state electrolyte sheet comprises an ionic conductivity at 850° C. of 9.5 S/m or more.

Aspect 52. The method of any one of aspects 25-51, wherein the solid-state electrolyte sheet comprises an ionic conductivity at 900° C. of 13.2 S/m or more.

Aspect 53. The method of any one of aspects 25-52, wherein the green tape, as a wt % of the green tape, comprises:
from 55 wt % to 70 wt % of the stabilized zirconia;
from 15 wt % to 25 wt % of a solvent;
from 10 wt % to 15 wt % of a polymeric binder;
from 0.1 wt % to 5 wt % of a dispersant; and
from 0.1 wt % to 2 wt % of a protic base.

Aspect 54. The method of any one of aspects 25-53, wherein the solid-state electrolyte sheet exhibits an edge strength of 350 MegaPascals or more as measured in a Two-Point Bend Test.

Aspect 55. The method of any one of aspects 25-54, wherein the stabilized zirconia used in the green tape comprises a specific surface area of 10.0 m²/g or less.

Aspect 56. The method of any one of aspects 25-55, wherein the stabilized zirconia used in the green tape comprises a median particle size from 0.3 μm to 1.0 μm.

Aspect 57. The method of any one of aspects 25-56, wherein the method produces the solid-state electrolyte sheet of any one of aspects 1-24.

Additional features and advantages will be set forth in the detailed description which follows, and in part will be readily apparent to those skilled in the art from that description or recognized by practicing the aspects and/or embodiments described herein, including the detailed description which follows, the claims, as well as the appended drawings

It is to be understood that both the foregoing general description and the following detailed description describe various aspects and are intended to provide an overview or framework for understanding the nature and character of the claimed subject matter. The accompanying drawings are included to provide a further understanding of the various aspects and are incorporated into and constitute a part of this specification. The drawings illustrate the various aspects described herein, and together with the description serve to explain the principles and operations of the claimed subject matter.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic cross-sectional view of a solid oxide electrolyzer cell in accordance with aspects of the present disclosure;

FIG. 2 is a schematic cross-sectional view of a solid oxide fuel cell in accordance with aspects of the present disclosure;

FIG. 3 is a schematic cross-section view of a solid-state electrolyte sheet in accordance with aspects of the present disclosure;

FIG. 4 is an enlarged view 4 of FIG. 3 showing a plurality of grains and a closed pore;

FIG. 5 is a flowchart of a method of manufacturing the solid-state electrolyte sheet shown in FIG. 3 and/or the cells shown in FIGS. 1-2 in accordance with aspects of the present disclosure;

FIG. 6 schematically illustrates a step of methods comprising forming a slip for a green tape in accordance with aspects of the present disclosure;

FIG. 7 schematically illustrates a temperature profile for firing a green tape in accordance with aspects of the present disclosure;

FIG. 8 schematically illustrates a temperature profile comprising a plurality of heating steps for firing a green tape in accordance with aspects of the present disclosure;

FIG. 9 schematically illustrates a step of firing a green tape in accordance with aspects of the present disclosure;

FIGS. 10-11 illustrate results of X-ray diffraction (XRD) analysis of Example 6;

FIG. 12 illustrates a phase diagram for scandia-stabilized zirconia;

FIG. 13 schematically illustrates a relationship between ionic conductivity in S/m at 800° C. on the vertical axis (i.e., y-axis) as a function of a ratio of a cubic phase to a tetragonal phase (C/T) on the horizontal axis (i.e., x-axis);

FIG. 14 schematically illustrates a relationship between ionic conductivity in S/m at 835° C. on the vertical axis (i.e., y-axis) as a function of a ratio of a cubic phase to a tetragonal phase (C/T) on the horizontal axis (i.e., x-axis);

FIG. 15 illustrate results of X-ray diffraction (XRD) analysis of Examples 25-26 and G-L; and

FIGS. 16-17 present enlarged portions of the XRD analysis in FIG. 15.

### DETAILED DESCRIPTION

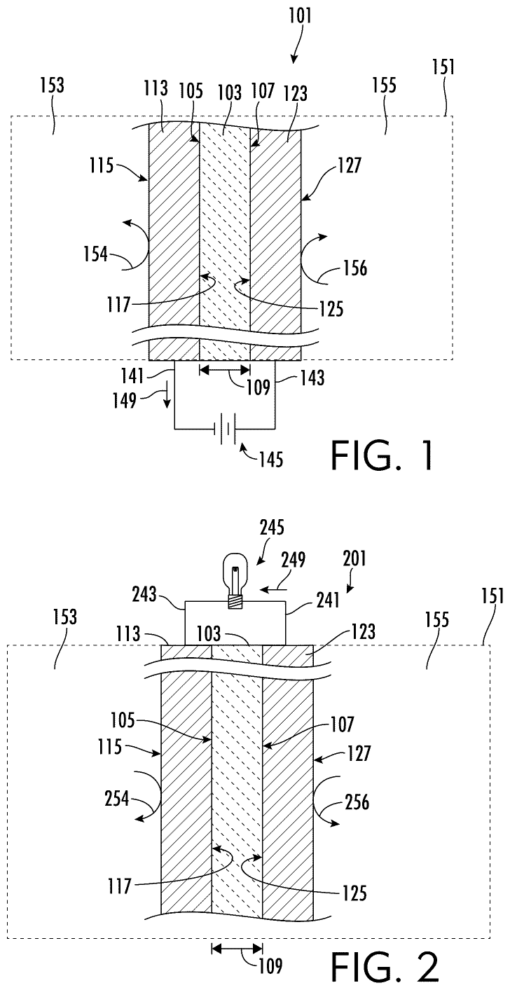

As shown in FIG. 1, a solid oxide electrolyzer cell 101 includes an oxygen electrode 113, a solid-state electrolyte sheet 103, and a fuel electrode 123 with the solid-state electrolyte sheet 103 positioned between the oxygen electrode 113 and the fuel electrode 123. As shown in FIG. 2, a solid oxide fuel cell 201 includes the oxygen electrode 113, the solid-state electrolyte sheet 103, and the fuel electrode 123 with the solid-state electrolyte sheet 103 positioned between the oxygen electrode 113 and the fuel electrode 123. As indicated by the common arrangement of the oxygen electrode 113, the solid-state electrolyte sheet 103, and the fuel electrode 123 for the solid oxide electrolyzer cell 101 and the solid oxide fuel cell 201, a common apparatus can be used as both the solid oxide electrolyzer cell 101 and the solid oxide fuel cell 201. Consequently, the oxygen electrode 113 and the fuel electrode 123, respectively, will be discussed together for the solid oxide electrolyzer cell 101 and the solid oxide fuel cell 201. Likewise, unless otherwise noted, a discussion of features of aspects of one solid-state electrolyte sheet can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As shown in FIG. 1, the solid oxide electrolyzer cell 101 can convert electrical energy (e.g., from a battery 145 or other power source flowing through wires 141 and 143 as shown by arrow 149) to chemical energy (e.g., as shown by reaction arrows 154 and 156 at the respective electrodes 113 and 123), for example, for energy storage, with oxygen ions traveling from the fuel electrode 123 to the oxygen electrode 113 through the solid-state electrolyte sheet 103. In contrast, as shown in FIG. 2, the solid oxide fuel cell 201 can convert chemical energy (e.g., as shown by reaction arrows 254 and 256 at the respective electrodes 113 and 123 in the opposite direction of reaction arrows 154 and 156 shown in FIG. 2) to electrical energy (e.g., that can be used to power a lightbulb 245 or other equipment such as a vehicle with electricity flowing through wires 241 and 243 as indicated by the arrow 249), for example, for energy production, with oxygen ions traveling from the oxygen electrode 113 to the fuel electrode 123 through the solid-state electrolyte sheet 103 (opposite the direction for the solid oxide electrolyzer cell 101).

As shown in FIGS. 1-2, the solid oxide electrolyzer cell 101 and/or the solid oxide fuel cell 201 includes the oxygen electrode 113 with a third major surface 117 facing and/or contacting a first major surface 105 of the solid-state electrolyte sheet 103. In aspects, the oxygen electrode can comprise at least one of iron (Fe), manganese (Mn), gadolinium (Gd), or combinations thereof. The oxygen electrode is configured to facilitate a reaction between an oxygen-containing source and oxygen ions (or vice versa). In aspects, as shown in FIGS. 1-2, the reaction is configured to occur at a fourth major surface 115 of the oxygen electrode 113 opposite the third major surface 117. For example, as shown in FIG. 1 by reaction arrow 154, the oxygen electrode 113 of the solid oxide electrolyzer cell 101 can facilitate a reaction (e.g., oxidation) from oxygen ions (e.g., O²⁻) traveling through the solid-state electrolyte sheet 103 from the fuel electrode 123 into an oxygen-containing compound (e.g., diatomic oxygen—O₂) that can be released into an oxygen-containing region 153 (and electrons—e⁻—that can travel through wire 141 as indicated by arrow 149 to the battery 145 or other power source). An example half-cell reaction occurring at the oxygen electrode 113 (e.g., fourth major surface 115) is O²⁻→½O₂+2e⁻. Alternatively, as shown in FIG. 2 by reaction arrow 254, the opposite reaction can occur at the oxygen electrode 113 (e.g., fourth major surface 115) converting (e.g., reducing) an oxygen-containing source (e.g., from the oxygen-containing region 153) into an oxygen ion (e.g., O²⁻ that can then travel into and/or through the solid-state electrolyte sheet 103) using electrons e⁻ (e.g., from wire 241 as indicated by arrow 249). In a case where the oxygen-containing source is diatomic oxygen, an example half-cell reaction occurring at the oxygen electrode 113 (e.g., fourth major surface 115) is ½O₂+2e⁻→O²⁻.

In aspects, the oxygen-containing region 153 can comprise any oxygen-containing material used or produced by reaction(s) occurring at the oxygen electrode 113. For example, the oxygen-containing material can be oxygen (e.g., diatomic oxygen), ozone, a peroxide (e.g., hydrogen peroxide), or a material containing one or more of the above (e.g., air containing oxygen). A preferred aspect of the oxygen-containing material is air, which naturally includes oxygen (i.e., diatomic oxygen). In aspects, as shown in FIGS. 1-2, the oxygen-containing region 153 can be demarcated by a body 151 of the corresponding cell or a device that is configured to utilize the corresponding cell. In further aspects, the oxygen-containing region 153 can be in fluid communication with an environment, for example, to allow the free flow of air therethrough (while the fuel-containing region 155 may not be open to the environment). Alternatively, in further aspects, the oxygen-containing region can be a cartridge or other storage device configured to supply the oxygen-containing material.

As shown in FIGS. 1-2, the solid oxide electrolyzer cell 101 and/or the solid oxide fuel cell 201 includes the fuel electrode 123 with a fifth major surface 125 facing and/or contacting a second major surface 107 of the solid-state electrolyte sheet 103. In aspects, the oxygen electrode can comprise at least one of nickel (Ni), manganese (Mn), chromium (Cr), scandium (Sc), or combinations thereof. The fuel electrode is configured to facilitate a reaction between an oxygen-accepting source and another oxygen-containing source (or vice versa). In aspects, as shown in FIGS. 1-2, the reaction is configured to occur at a sixth major surface 127 of the fuel electrode 123 opposite the fifth major surface 125. For example, as shown in FIG. 1 by reaction arrow 156, the fuel electrode 123 of the solid oxide electrolyzer cell 101 can facilitate a conversion (e.g., reduction) of the another oxygen-containing source from a fuel-containing region 155 (and electrons—e⁻—that can travel through wire 143 as indicated by arrow 149 from the battery 145 or other power source) to form the oxygen-accepting source. In case where the another oxygen-containing source is water (H₂O), an example half-cell reaction occurring at the fuel electrode 123 (e.g., sixth major surface 127) is H₂O+2e⁻→H₂+O²⁻. Alternatively, as shown in FIG. 2 by reaction arrow 256, the opposite reaction can occur at the fuel electrode 123 (e.g., sixth major surface 127) involving reacting (e.g., oxidizing) the oxygen-accepting source with an oxygen ion (e.g., O²⁻ that travelled through the solid-state electrolyte sheet 103 from the oxygen electrode 113) to form the oxygen-containing source and releasing electrons e⁻ that can travel along wire 241 as indicated by arrow 249 (e.g., that can be used to power a lightbulb 245 or other equipment such as a vehicle). In a case where the oxygen-accepting source is hydrogen H₂, an example half-cell reaction occurring at the fuel electrode 123 (e.g., sixth major surface 127) is H₂+O²⁻→H₂O+2e⁻.

In aspects, the fuel-containing region 155 can comprise any oxygen-accepting material (e.g., “fuel”) used or produced by reaction(s) occurring at the fuel electrode 123 and/or any oxygen-containing material configured to be used in the reverse reaction (e.g., reaction arrow 256). For example, the another oxygen-containing material can be water (e.g., diatomic oxygen), a peroxide (e.g., hydrogen peroxide), alcohols (e.g., methanol, ethanol), an alkali-containing material (e.g., potassium carbonate), or a material containing one or more of the above. A preferred aspect of the another oxygen-containing material is water (i.e., H₂O). The oxygen-accepting material can be a material corresponding to the another oxygen-containing material after an oxidation reaction with an oxygen ion. For example, the oxygen-accepting material can be hydrogen (e.g., H₂), a hydrocarbon (e.g., methane, ethane, syngas, natural gas), an alkali-containing material (e.g., an alkali hydroxide, for example potassium hydroxide, which can be used in combination with carbon dioxide), or a material containing one or more of the above. A preferred aspect of the oxygen-accepting material is hydrogen (i.e., H₂). In aspects, as shown in FIGS. 1-2, the fuel-containing region 155 can be demarcated by a body 151 of the corresponding cell or a device that is configured to utilize the corresponding cell. In further aspects, the fuel-containing region 155 can be a cartridge or other storage device configured to supply the oxygen-accepting material.

In aspects, although not shown, a current collector can be disposed on the oxygen electrode and/or the fuel electrode, for example, to facilitate the attachment of and/or conveyance of electrons to and/or from the wires. Alternatively, in aspects, as shown in FIGS. 1-2, the wires can be directly attached to the corresponding electrodes. For example, one or both of the electrodes may function as a current collector in addition to being an electrode.

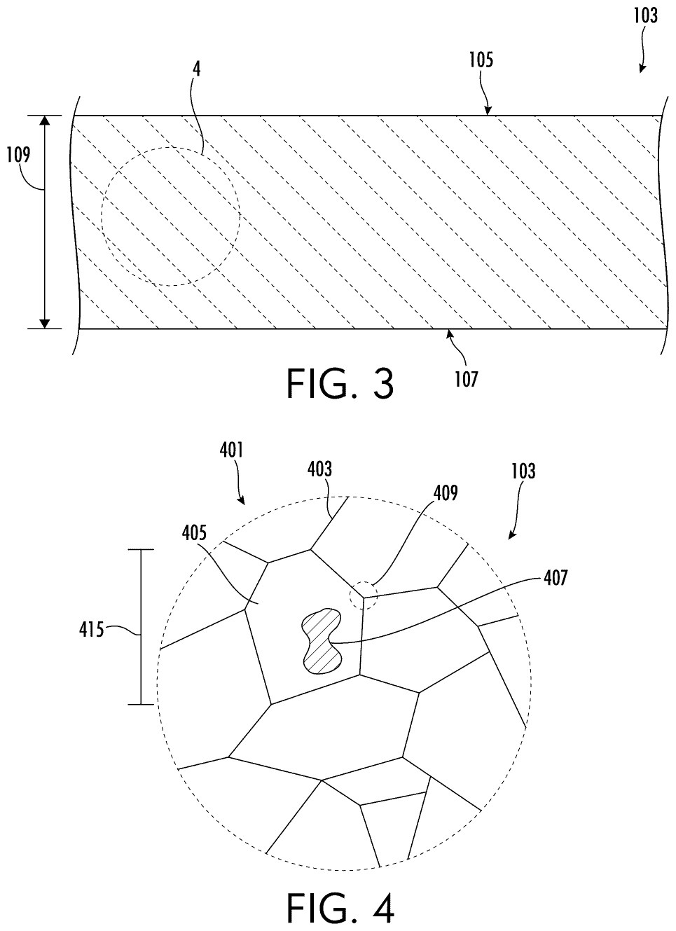

As shown in FIGS. 1-3, the solid-state electrolyte sheet 103 comprises a first major surface 105 and a second major surface 107 opposite the first major surface 105. In aspects, as shown in FIGS. 1-2, the first major surface 105 of the solid-state electrolyte sheet 103 can face and/or contact the third major surface 117 of the oxygen electrode 113. In aspects, as shown in FIGS. 1-2, the second major surface 107 of the solid-state electrolyte sheet 103 can face and/or contact the fifth major surface 125 of the fuel electrode 123. As shown, a thickness 109 of the solid-state electrolyte sheet 103 is defined as an average distance between the first major surface 105 and the second major surface 107. In aspects, the thickness 109 can be 10 micrometers (μm) or more, 15 μm or more, 20 μm or more, 25 μm or more, 30 μm or more, 35 μm or more, 40 μm or more, 300 μm or less, 200 μm or less, 160 μm or less, 120 μm or less, 100 μm or less, 80 μm or less, 60 μm or less, 50 μm or less, or 40 μm or less. In aspects, the thickness 109 can be in a range from 10 μm to 300 μm, from 10 μm to 200 μm, from 10 μm to 160 μm, from 15 μm to 120 μm, from 15 μm to 100 μm, from 20 μm to 80 μm, from 20 μm to 60 μm, from 20 μm to 50 μm, from 25 μm to 50 μm, from 30 μm to 50 μm, or any range or subrange therebetween. In further aspects, preferred ranges for the thickness 109 can be from 10 μm to 300 μm, from 20 μm to 50 μm, or from 30 μm to 50 μm. The thickness 109 of the solid-state electrolyte sheet 103 can be determined from a scanning electron microscope (SEM) image of a cross-section of the solid-state electrolyte sheet 103, for example with the view shown in FIG. 3. In aspects, a maximum dimension (e.g., length) of the solid-state electrolyte sheet 103 can be 100 millimeters (mm or more), 500 mm or more, 1 meter (m) or more, 5 meters or more, 10 meters or more, 20 meters or more, 50 meters or more, or 100 meters or more, for example, in a range from 100 mm to 1,000 meters, from 500 mm to 500 mm, from 1 meter to 200 meters, from 5 meters to 100 meters, from 10 meters to 50 meters, or any range or subrange therebetween. Methods of the present disclosure can enable the formation of long ribbons of the solid-state electrolyte sheet.

FIG. 3 shows the solid-state electrolyte sheet 103, and FIG. 4 shows an enlarged view 4 of FIG. 3. The solid-state electrolyte sheet 103 comprises stabilized zirconia grains. For example, FIG. 4 shows a plurality of grains 401 with grain boundaries 403. In aspects, the solid-state electrolyte sheet 103 is an inorganic material, which can be free of organic materials. For example, the solid-state electrolyte sheet 103 can be distinguished from a polymeric electrolyte sheet (e.g., a PFSA electrolyte). In aspects, the solid-state electrolyte sheet 103 consists essentially of or consists of stabilized zirconia. In aspects, an amount of stabilized zirconia in solid-state electrolyte sheet 103, based on 100 wt % of the solid-state electrolyte sheet 103, can be 70 wt % or more, 80 wt % or more, 85 wt % or more, 90 wt % or more, 95 wt % or more, 99 wt % or more, 99.5 wt % or more, 99.9 wt % or more, or 100 wt %.

As used herein, “stabilized zirconia” means that zirconia contains a dopant as a stabilizer. In aspects, an amount of dopant in the stabilized zirconia grains, as a mol % of the stabilized zirconia grains, can be 3 mol % or more, 4 mol % or more, 5 mol % or more, 5.5 mol % or more, about 6 mol % or more, 8 mol % or more, 9 mol % or more, about 10 mol % or more, 12 mol % or less, 11 mol % or less, 10.5 mol % or less, about 10 mol % or less, 8 mol % or less, 7 mol % or less, 6.5 mol % or less, or about 6 mol % or less. As used herein, “about” for the mol % of the dopant includes amounts that would round to the stated number in the stated precision; for example, “about 6 mol %” includes from 5.5 mol % to 6.4 mol % since amounts in that range would round to 6 mol % at the stated level of precision; likewise, “about 10 mol %” includes from 9.5 mol % to 10.4 mol %. In aspects, an amount of dopant in the stabilized zirconia grains, as a mol % of the stabilized zirconia grains, can be in a range from 3 mol % to 12 mol %, from 3 mol % to 11 mol %, from 3 mol % to about 10 mol %, from 4 mol % to 9 mol %, from 4 mol % to 8 mol %, from 5 mol % to 7 mol %, from 5.5 mol % to about 6 mol %, or about 6 mol %. In preferred aspects, the scandia-stabilized zirconia grains can include from 3 mol % to 12 mol %, from 3 mol % to about 6 mol % (e.g., about 6 mol %), or from 8 mol % to 12 mol % (e.g., about 10 mol %).

The dopant in the stabilized zirconia can be selected from a group consisting of alumina, cerium oxide, gadolinium oxide, scandia, yttria, ytterbia, and combinations thereof. For example, in aspects, the dopant can predominantly comprise one component (e.g., scandia) and one or more additional dopants in lesser amounts. Alternatively, the dopant can comprise (e.g., consist of) a single component (e.g., scandia). In exemplary aspects, the dopant can be scandia, for example, in amounts of from 3 mol % to 12 mol %, 3 mol % to 6 mol % (e.g., 6 mol %), or from 8 mol % to 12 mol % (e.g., 10 mol %). In aspects, scandia-stabilized zirconia (e.g., stabilized zirconia with a scandia dopant) can be free of at least one of alumina, yttria, a lanthanoid oxide, or combinations thereof. Unless otherwise indicated, as used herein, the term “free” does not require absolute precision nor atomic-scale accuracy, but rather “free” means that the component may be present in the final glass-based composition in very small amounts (e.g., as a contaminant, such as less than 0.1 mol %) that could be practically obtained by a reasonable practitioner, which does include 0.0 mol % in some aspects.

Throughout the disclosure, a crystallinity and/or relative proportion of crystal phases can be determined using X-ray diffraction (XRD). Using the reference crystallographic data for zirconia and stabilized zirconia crystal phases, a measured XRD spectrum can be fit with a series of curves associated with different aspects of the various crystal phases. A total area of the fitted curves associated with each crystal phase relative to the total area of all fitted curves is assumed to be proportional to a relative amount of the corresponding crystal phase in the sample. Unless otherwise indicated, amounts of the cubic phase and tetragonal phase are determined by analysis of the scattering peak around 60° (double angle). The scattering peak at 60° appears to be less noisy (and easier to distinguish contributions from each crystal type) than other peaks such that analysis of the peaks near 60° provides more reproducible results than including peaks at other angles (e.g., about 30°, about 35°, about 50°, or about) 72°. Specifically, when discussing the ratio of the cubic phase to the tetragonal phase (C/T ratio), the analysis is based on the peaks around 60° (double angle).

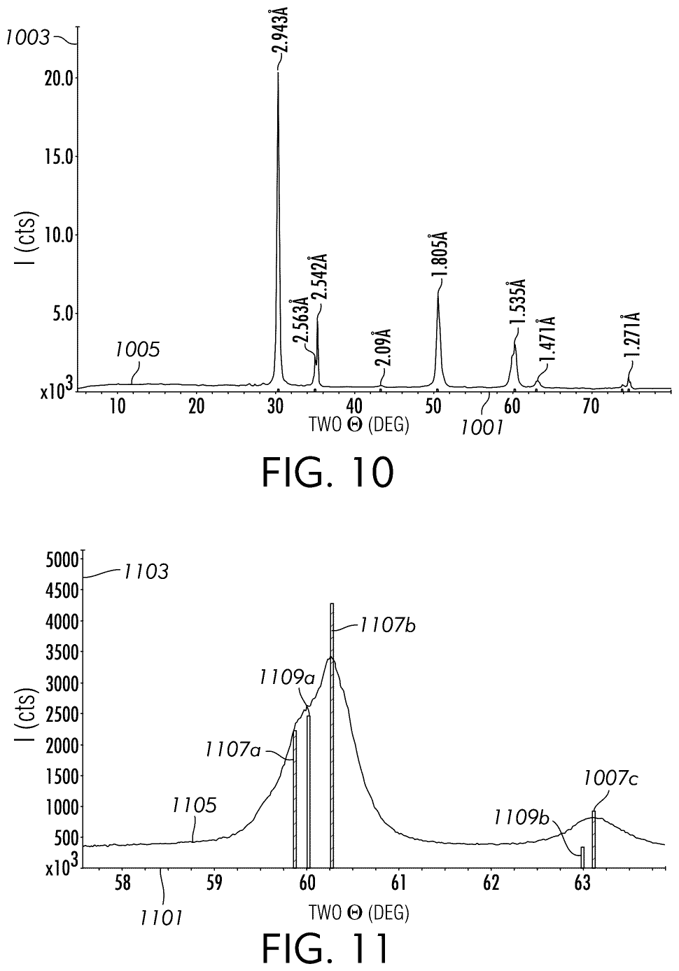

In aspects, the stabilized zirconia can comprise a cubic phase. In further aspects, the cubic phase can be the predominant crystal phase in the stabilized zirconia. As used herein, a “predominant crystal phase” has a relative amount in the stabilized zirconia grains that is greater than any of other crystal phases on their own. Alternatively or additionally, the stabilized zirconia can comprise a tetragonal phase. In further aspects, the tetragonal phase can be the predominant crystal phase in the stabilized zirconia. In further aspects, an amount of the tetragonal crystal phase, as percentage of all crystal phases in the stabilized zirconia grains, can be 50% or more, 66% or more, 75% or more, 80% or more, 85% or more, 90% or more, 92% or more, 95% or more, 96% or more, 97% or more, 98% or more, or 99% or more. For example, FIGS. 10-11 show XRD spectra of Example 6. In FIGS. 10-11, the horizontal axis 1001 or 1101 (e.g., x-axis) corresponds to two theta (2θ) in degrees (°), where θ is the inclination of the incident X-rays that is detected at a diffraction angle of 2θ; and the vertical axis 1003 or 1103 is a relative intensity of the diffraction peaks that is proportional to a number of detected diffracted X-rays. In FIG. 10, spectrum 1005 shows several diffraction peaks that are all associated with the tetragonal crystal phase. Based on the literature, spectrum 1005 is believed to have greater than 99% (e.g., about 100%) of the crystal phases in tetragonal phase. In FIG. 11, additional sampling was performed and the zoomed-in portion of the spectrum 1105 shows two peaks that can be fit using curves centered at the locations shown, where curves 1107a-1107c are associated with the tetragonal crystal phase and curves 1109a-b are associated with a cubic zirconia crystal phase. In combination with the other diffraction peaks (including those outside of the zoomed-in range shown in FIG. 26), a relative amount of the tetragonal crystal phase in the stabilized zirconia grains is still estimated to be 99% or more based on methods in the literature.

Alternatively or additionally, in aspects, the stabilized zirconia can comprise a mixture of a cubic phase and a tetragonal phase. In further aspects, a ratio of the cubic phase to the tetragonal phase (C/T ratio) in the stabilized zirconia grains (e.g., of the solid-state electrolyte sheet) can be 0.12 or more, 0.15 or more, 0.17 or more, 0.20 or more, 0.22 or more, 0.25 or more, 0.27 or more, 0.30 or more, 0.32 or more, 0.35 or more, 0.90 or less, 0.75 or less, 0.60 or less, 0.50 or less, 0.45 or less, 0.42 or less, 0.40 or less, 0.35 or less, 0.32 or less, 0.30 or less, 0.28 or less, or 0.25 or less. In further aspects, a C/T ratio in the stabilized zirconia grains (e.g., of the solid-state electrolyte sheet) can be in a range from 0.12 to 0.90, from 0.15 to 0.75, from 0.17 to 0.60, from 0.20 to 0.50, from 0.22 to 0.45, from 0.25 to 0.42, from 0.27 to 0.40, from 0.30 to 0.35, or any range or subrange therebetween. In preferred aspects, the C/T ratio can be from 0.12 to 0.50, from 0.15 to 0.45, or from 0.27 to 0.42.

Without wishing to be bound by theory, it is now believed that the addition of cubic phases in the stabilized zirconia provides increased ionic conductivity, especially when the C/T ratio is within one or more of the ranges discussed herein. At least for scandia-stabilized zirconia, it is believed that the literature to date has reported that the tetragonal phase is the dominant phase in the grains of stabilized zirconia and that heating (as in the firing of green tapes) further decreases the presence of any cubic phase. Consequently, it would be expected that the C/T ratio for stabilized zirconia in sintered tapes would be extremely low (e.g., 0.08 or less). However, as demonstrated by the examples here, quenching the sintered tapes (after the heating of the green tape) as part of the firing process unexpectedly increases the presence of the cubic phase (i.e., increases the C/T ratio to greater than or equal 0.10) and unexpectedly increases the ionic conductivity of resulting solid-state electrolyte sheet.

Throughout the disclosure, a grain size of the stabilized zirconia grains is determined in accordance with ASTM E112-13. As such, a scanning electron microscope (SEM) image is taken of a cross-section (as shown schematically in FIG. 4 and from experimental measurement of Examples 1-24 in FIGS. 10-24 and 27-39). For determining the grain size distribution (e.g., minimum, maximum, mean), the SEM images was taken at 20,000 times magnification and at least 20% of the area in the SEM image is analyzed to determine the grain size distribution. For example, a grain size 415 is shown for grain 405 of the plurality of grains in FIG. 4. From the calculated grain sizes, values such as the average (e.g., mean), maximum, and minimum values of the resulting distribution of grain sizes can be calculated. In aspects, an average (e.g., mean) grain size of the stabilized zirconia grains can be 2.5 μm or less, 2.2 μm or less, 2.0 μm or less, 1.8 μm or less, 1.5 μm or less, 1.2 μm or less, 1.0 μm or less, 0.9 μm or less, 0.8 μm or less or less, 0.7 μm or less, 0.6 μm or less, 0.5 μm or less, 0.1 μm or more, 0.2 μm or more, 0.3 μm or more, 0.4 μm or more, 0.5 μm or more, 0.6 μm or more, 0.7 μm or more, 0.8 μm or more, 0.9 μm or more, 1.0 μm or more, 1.01 μm or, 1.1 μm or more, 1.2 μm or more, 1.3 μm or more, 1.5 μm or more, 1.8 μm or more, or 2.0 μm or more. In aspects, the average (e.g., mean) grain size of the stabilized zirconia grains can in a range from 0.1 μm to 2.5 μm, from 0.1 μm to 2.2 μm, from 0.2 μm to 2.0 μm, from 0.2 μm to 1.8 μm, from 0.3 μm to 1.5 μm, from 0.3 μm to 1.2 μm, from 0.4 μm to 1.0 μm, from 0.4 μm to 0.9 μm, from 0.5 μm to 0.8 μm, from 0.5 μm to 0.7 μm, or any range or subrange therebetween. In aspects, the average grain size of the stabilized zirconia grains can be 1.01 μm or more, for example, in a range from 1.01 μm to 2.5 μm, from 1.01 μm to 2.2 μm, from 1.1 μm to 2.0 μm, from 1.2 μm to 1.8 μm, from 1.3 μm to 1.5 μm, or any range or subrange therebetween. In aspects, the average grain size of the stabilized zirconia grains can be in a range from 0.1 μm to 1.8 μm, from 0.1 μm to 1.5 μm, from 0.1 μm to 1.2 μm, from 0.1 μm to 1.0 μm, from 0.1 μm to 0.8 μm, from 0.1 μm to 0.7 μm, from 0.1 μm to 0.6 μm, from 0.1 μm to 0.5 μm, from 0.2 μm to 0.4 μm, or any range or subrange therebetween. In aspects, preferred ranges for the average grain size of the stabilized zirconia grains can be in a range from 0.1 μm to 2.5 μm, from 1.01 μm to 2.2 μm, or from 0.1 μm to 1.5 μm. Without wishing to be bound by theory, it is believed that providing a low average grain size (e.g., from 0.1 μm to 2.5 μm) can increase the ionic conductivity, for example, by decreasing a path length along grain boundaries that could be travelled by ion transported through the solid-state electrolyte sheet.

In aspects, a maximum grain size of the stabilized zirconia grains can be 5 μm or less, 4.5 μm or less, 4 μm or less, 3.5 μm or less, 3 μm or less, 2.8 μm or less, 2.5 μm or less, 2.2 μm or less, 2.0 μm or less, 1.8 μm or less, 1.5 μm or less, 1.2 μm or less, 1.0 μm or less, 0.8 μm or less, or 0.5 μm or less. In aspects, a maximum grain size of the stabilized zirconia grains can be in a range from 0.1 μm to 5 μm, from 0.2 μm to 4.5 μm, from 0.3 μm to 4 μm, from 0.4 μm to 3.5 μm, from 0.5 μm to 3 μm, from 0.6 μm to 2.8 μm, from 0.7 μm to 2.5 μm, from 0.8 μm to 2.2 μm, from 0.9 μm to 2.0 μm, from 1.0 μm to 1.8 μm, from 1.2 μm to 1.5 μm, or any range or subrange therebetween. In aspects, a distribution of grain sizes of the stabilized zirconia grains can be contained in a range from 0.1 μm to 5 μm, from 0.1 μm to 4 μm, from 0.1 μm to 3 μm, from 0.1 μm to 2.8 μm, from 0.1 μm to 2.5 μm, from 0.1 μm to 2.2 μm, from 0.1 μm to 2.0 μm, from 0.1 μm to 1.8 μm, from 0.1 μm to 1.5 μm, from 0.1 μm to 1.2 μm, from 0.1 μm to 1.0 μm, from 0.1 μm to 0.8 μm, from 0.1 μm to 0.5 μm, or any range or subrange therebetween. Without wishing to be bound by theory, it is believed that by limiting a maximum grain size, the ionic conductivity can be increased, for example, by decreasing a path length along grain boundaries that could be travelled by ion transported through the solid-state electrolyte sheet and/or by providing additional grain boundary per volume of the solid-state electrolyte.

Throughout the disclosure, the porosity of the solid-state electrolyte sheet is determined in accordance with ASTM E1245-03. For example, the SEM image used for determining grain size can be reanalyzed to determine the number and size of pores. However, as used herein, the porosity is determined from SEM images at 5,000 times magnification, where at least 20% of each SEM image is analyzed, and the results of analyzing seven (7) SEM images are averaged to determine the porosity distribution (e.g., minimum, maximum, mean). As schematically illustrated in FIG. 4, the solid-state electrolyte sheet 103 can have closed pores 407 or open pores (indicated by region 409). As used herein, closed pores occur within a grain and are unlikely to continue beyond the grain. As such, a path cannot be formed through the thickness of the solid-state electrolyte sheet using closed grains. In contrast, as used herein, open pores occur at grain boundaries (e.g., region 409 is located at the intersection of grain boundaries 403 and can form a continuous path through the solid-state electrolyte sheet 103. In aspects, a majority (e.g., greater than 50%) of pores in the solid-state electrolyte sheet 103 can be closed pores. In aspects, a percentage of pores in the solid-state electrolyte sheet 103 that are closed pores can be 55% or more, 66% or more, 75% or more, 80% or more, 85% or more, 90% or more, 95% or more, 97% or more, 99% or more, 100% or less, 99% or less, 98% or less, 96% or less, 94% or less, 92% or less, 90% or less, 88% or less, 85% or less, or 80% or less. In aspects, a percentage of pores in the solid-state electrolyte sheet 103 that are closed pores can be in a range from 55% to 100%, from 66% to 99%, from 75% to 98%, from 80% to 96%, from 82% to 94%, from 85% to 92%, from 90% to 92%, or any range or subrange therebetween. Without wishing to be bound by theory, it is believed that ionic conductivity decreases exponentially with increasing open porosity. Providing a majority of pores as closed pores can enable an increased ionic conductivity. Also, providing a majority of pores as closed pores can facilitate longevity of the resulting solid oxide fuel cell and/or solid oxide electrolyzer cell, for example, by reducing an incidence of short circuiting the cell through the solid state electrolyte sheet (e.g., in the case of an open pore providing a path from the first major surface to the second major surface).

In aspects, a porosity of the solid-state electrolyte sheet 103 can be 4% or less, 3% or less, 2.0% or less, 1.5% or less, 1.2% or less, 1.0% or less, 0.8% or less, 0.5% or less, 0.01% or more, 0.05% or more, 0.10% or more, 0.15% or more, 0.20% or more, 0.3% or more, 0.4% or more, or 0.5% or more. In aspects, a porosity of the solid-state electrolyte sheet 103 can be in a range from 0.01% to 4%, from 0.05% to 3%, from 0.10% to 2.0%, from 0.15% to 1.5%, from 0.20% to 1.2%, from 0.3% to 1.0%, from 0.4% to 0.8%, from 0.4% to 0.5%, or any range or subrange therebetween. In preferred aspects, the porosity can be in a range from 0.01% to 4%, from 0.05% to 1.0%, and from 0.10% to 0.5%.

The solid-state electrolyte sheet 103 can have low curvature and/or low surface variability. Throughout the disclosure, a “surface profile” of the solid-state electrolyte sheet is determined using a LJ-X line profilometer available from Keyence. The solid-state electrolyte sheet is freely resting on a flat surface (i.e., not restrained) when the optical measurements used to determine the surface profile are taken. Measurements are taken every 333 μm (i.e., 3 times every millimeter). As used herein, the “total-indicated-range” (TIR) is measured for measured heights within 1 mm (exclusive) of one another (i.e., a sliding window of 3 measurements when measurements are taken 3 times every millimeter) as the maximum difference in measured height between those measurements. The TIR reported and claimed herein are described as being for a predetermined length of a surface of the solid-state electrolyte sheet to provide a representative sampling of the variability in surface height across the solid-state electrolyte sheet. When the TIR is reported for a length greater than 1 mm, the reported TIR is the average TIR measured for the 1 mm sliding windows contained within that length. For example, a TIR reported over a length of 25 mm refers to the average of the maximum differences between pairs of points within 1 mm (exclusive) of each other (i.e., the maximum value of the maximum differences calculated for 74 different positions for the 1 mm sliding window and then those measurements are averaged). In aspects, a TIR of the solid-state electrolyte sheet 103 over a distance of 25 mm or more can be 1.5 mm or less, 1.0 mm or less, 0.9 mm or less, 0.8 mm or less, 0.7 mm or less, 0.5 mm or less, 0.4 mm or less, 0.3 mm or less, 0.1 mm or more, 0.2 mm or more, 0.3 mm or more, or 0.5 mm or more. In aspects, a TIR of the solid-state electrolyte sheet 103 over a distance of 25 mm or more can be in range from 0.1 mm to 1.5 mm, from 0.1 mm to 1.0 mm, from 0.1 mm to 0.9 mm, from 0.1 mm to 0.8 mm, from 0.2 mm to 0.7 mm, from 0.3 mm to 0.6 mm, from 0.4 mm to 0.5 mm, or any range or subrange therebetween. In aspects, the TIR of the solid-state electrolyte sheet 103 over a distance of 25 mm can be within one or more of the ranges discussed above. In aspects, the TIR of the solid-state electrolyte sheet 103 over a distance of 50 mm can be within one or more of the ranges discussed above. In aspects, the TIR of the solid-state electrolyte sheet 103 over a distance of 100 mm can be within one or more of the ranges discussed above. In aspects, the TIR of the solid-state electrolyte sheet 103 over a distance of 150 mm can be within one or more of the ranges discussed above. In aspects, the TIR of the solid-state electrolyte sheet 103 over a distance of 170 mm can be within one or more of the ranges discussed above.

Throughout the disclosure, a curvature of the solid-state electrolyte sheet is characterized in terms of optical power (in units of diopters (D)). As with TIR, curvature is calculated using measurements within 1 mm (exclusive) of one another with the measurements taken from the surface profile described above. The curvature reported here is the average (e.g., mean) of all the curvatures calculated for a surface of the solid-state electrolyte sheet. In aspects, the curvature of the solid-state electrolyte sheet 103 can be 12 D or less, 10 D or less, 8 D or less, 7 D or less, 6 D or less, 5 D or less, 4 D or less, 3.5 D or less, 3 D or less, 2.5 D or less, 2 D or less, 0.1 D or more, 0.5 D or more, 1 D or more, 2 D or more, 2.5 D or more, 3 D or more, 4 D or more, or 5 D or more. In aspects, the curvature of the solid-state electrolyte sheet 103 can be in a range from 0.1 D to 12 D, from 0.1 D to 10 D, from 0.5 D to 8 D, from 0.5 D to 7 D, from 1 D to 6 D, from 1 D to 5 D, from 2 D to 4 D, from 2 D to 3.5 D, from 2.5 D to 3 D, or any range or subrange therebetween.

The ionic conductivity of the solid-state electrolyte sheet 103 is a quantification of the ability of the solid-state electrolyte sheet to transport ions (e.g., oxygen ions) between the oxygen electrode and the fuel electrode or vice versa. Throughout the disclosure, the ionic conductivity is measured at a predetermined temperature (e.g., 800° C., 850° C., 900° C., 950° C.) using a 4-point probe. The 4-point probe comprises a pair of current probes and a pair of voltage probes arranged on a common surface of the solid-state electrolyte sheet such that the pair of voltage probes are separated by a distance of 21 mm, the current probes bracket the pair of voltage probes (i.e., are positioned outside of the distance between the pair of voltage probes), and the probes are attached to the common surface of the solid-state electrolyte sheet using platinum paste with a thickness of 40 μm and a width of 5 mm in the direction that the distance between the pair of voltage probes is measured. Current is passed between the pair of current probes and the change in voltage detected by the pair of voltage probes is monitored. Based on these measurements, ionic conductivity is calculated. Examples 1-26 demonstrate an unexpected benefit of increased ionic conductivity beyond that reported in the prior art under similar conditions. Further, Examples 25-26 demonstrate the highest ionic conductivity and C/T ratio, which is associated with quenching the sintered tape. Without wishing to be bound by theory, it is believed that the C/T ratio, closed porosity, small average grain size, small maximum grain size, and/or low porosity (e.g., formed as a result of the methods of the present disclosure) contribute to the unexpectedly high ionic conductivity.

In aspects, an ionic conductivity of the solid-state electrolyte sheet 103 at 800° C. can be 6.5 Siemens per centimeter (S/m) or more, 6.6 S/m or more, 6.7 S/m or more, 6.79 S/m or more, 6.8 S/m or more, 6.9 S/m or more, 7.0 S/m or more, 7.05 S/m or more, 7.1 S/m or more, 10.0 S/m or less, 8.0 S/m or less, 7.5 S/m or less, 7.3 S/m or less, 7.2 S/m or less, 7.1 S/m or less, or 7.0 S/m or less. In aspects, an ionic conductivity of the solid-state electrolyte sheet 103 at 800° C. can be in a range from 6.5 S/m to 10.0 S/m, from 6.6 S/m to 8.0 S/m, from 6.7 S/m to 7.5 S/m, from 6.79 S/m to 7.3 S/m, from 6.9 S/m to 7.2 S/m, from 7.0 S/m to 7.1 S/m, from 7.05 S/m to 7.1 S/m, or any range or subrange therebetween. In preferred aspects, the ionic conductivity at 800° C. can be from 6.5 S/m to 10 S/m, from 6.79 S/m to 8.0 S/m, or from 7.0 S/m to 7.5 S/m. As demonstrated below for Examples 1-24, ionic conductivity at 800° C. of greater than 6.5 S/m (e.g., from 6.7 S/m to 7.1 S/m) have been achieved. Likewise, Examples 25-26 have an ionic conductivity at 800° C. of greater than 6.5 S/m (e.g., greater than 6.7 S/m) with Example 25 have an ionic conductivity of 7.10 S/m.

In aspects, an ionic conductivity of the solid-state electrolyte sheet 103 at 835° C. can be 8.5 Siemens per centimeter (S/m) or more, 8.7 S/m or more, 8.8 S/m or more, 8.9 S/m or more, 9.0 S/m or more, 9.1 S/m or more, 11.0 S/m or more, 10.0 S/m or more, 9.8 S/m or less, 9.5 S/m or more, 9.3 S/m or less, 9.2 S/m or less, 9.1 S/m or less, 9.0 S/m or less, 7.2 S/m or less, 7.1 S/m or less, or 7.0 S/m or less. In aspects, an ionic conductivity of the solid-state electrolyte sheet 103 at 835° C. can be in a range from 8.5 S/m to 11.0 S/m, from 8.7 S/m to 10.0 S/m, from 8.8 S/m to 9.8 S/m, from 8.9 S/m to 9.5 S/m, from 9.0 S/m to 9.3 S/m, from 9.1 S/m to 9.2 S/m, or any range or subrange therebetween. In preferred aspects, the ionic conductivity at 835° C. can be from 8.5 S/m to 11.0 S/m, from 8.8 S/m to 10.0 S/m, or from 9.0 S/m to 9.5 S/m. As demonstrated below, Examples 25-26 have an ionic conductivity at 835° C. of greater than 8.5 S/m (e.g., greater than 8.8 S/m) with Example 25 have an ionic conductivity of greater than 9.0 S/m (e.g., 9.1 S/m or more).

In aspects, an ionic conductivity of the solid-state electrolyte sheet 103 at 850° C. can be 9.5 Siemens per centimeter (S/m) or more, 9.6 S/m or more, 9.7 S/m or more, 9.8 S/m or more, 9.9 S/m or more, 10.0 S/m or more, 10.1 S/m or more, 10.2 S/m or more, 10.3 S/m or more, 10.4 S/m or more, 12.0 S/m or less, 11.0 S/m or less, 10.7 S/m or less, 10.5 S/m or less, 10.4 S/m or less, 10.3 S/m or less, 10.2 S/m or less, 10.1 S/m or less, or 10.0 S/m or less. In aspects, an ionic conductivity of the solid-state electrolyte sheet 103 at 850° C. can be in a range from 9.5 S/m to 12.0 S/m, from 9.6 S/m to 11.0 S/m, from 9.7 to 10.7 S/m, from 9.8 S/m to 10.5 S/m, from 9.9 S/m to 10.4 S/m, from 10.0 S/m to 10.3 S/m, from 10.1 S/m to 10.2 S/m, or any range or subrange therebetween. As demonstrated below for Examples 1-24, ionic conductivity at 850° C. of greater than 9.5 S/m (e.g., from 9.8 S/m to 10.1 S/m) have been achieved.

In aspects, an ionic conductivity of the solid-state electrolyte sheet 103 at 900° C. can be 13.0 S/m or more, 13.2 S/m or more, 13.4 S/m or more, 13.5 S/m or more, 13.6 S/m or more, 13.7 S/m or more, 13.8 S/m or more, 13.9 S/m or more, 14.0 S/m or more, 14.1 S/m or more, 14.2 S/m or more, 14.3 S/m or more, 14.4 S/m or more, 14.5 S/m or more, 16.0 S/m or less, 15.5 S/m or less, 15.0 S/m or less, 14.8 S/m or less, 14.7 S/m or less, 14.6 S/m or less, 14.5 S/m or less, 14.4 S/m or less, 14.3 S/m or less, 14.2 S/m or less, or 14.1 S/m or less. In aspects, an ionic conductivity of the solid-state electrolyte sheet 103 at 900° C. can be in a range from 13.0 S/m to 16.0 S/m, from 13.2 S/m to 15.5 S/m, from 13.4 S/m to 15.0 S/m, from 13.5 S/m to 14.8 S/m, from 13.6 S/m to 14.7 S/m, from 13.7 S/m to 14.6 S/m, from 13.8 S/m to 14.5 S/m, from 13.9 S/m to 14.4 S/m, from 14.0 S/m to 14.3 S/m, from 14.1 S/m to 14.2 S/m, or any range or subrange therebetween. As demonstrated below for Examples 1-24, ionic conductivity at 900° C. of greater than 13.2 S/m (e.g., from 13.5 S/m to 14.1 S/m) have been achieved.

In aspects, an ionic conductivity of the solid-state electrolyte sheet 103 at 950° C. can be 18.0 S/m or more, 18.2 S/m or more, 1.4 S/m or more, 18.5 S/m or more, 18.6 S/m or more, 18.7 S/m or more, 18.8 S/m or more, 18.9 S/m or more, 19.0 S/m or more, 19.1 S/m or more, 19.2 S/m or more, 19.3 S/m or more, 19.4 S/m or more, 19.5 S/m or more, 22.0 S/m or less, 21.0 S/m or less, 20.5 S/m or less, 20.2 S/m or less, 20.0 S/m or less, 19.8 S/m or less, 19.7 S/m or less, 19.6 S/m or less, 19.5 S/m or less, 19.4 S/m or less, or 19.3 S/m or less. In aspects, an ionic conductivity of the solid-state electrolyte sheet 103 at 950° C. can be in a range from 18.0 S/m to 22.0 S/m, from 18.2 S/m to 21.0 S/m, from 18.4 S/m to 20.5 S/m, from 18.5 S/m to 20.2 S/m, from 18.6 S/m to 20.0 S/m, from 18.7 S/m to 19.8 S/m, from 18.8 S/m to 19.7 S/m, from 18.9 S/m to 19.6 S/m, from 19.0 S/m to 19.5 S/m, from 19.1 S/m to 19.4 S/m, from 19.2 S/m to 19.3 S/m, or any range or subrange therebetween. As demonstrated below for Examples 1-24, ionic conductivity at 950° C. of greater than 18.0 S/m (e.g., from 18.5 S/m to 19.3 S/m) have been achieved.

Throughout the disclosure, “edge strength” is measured in Two-Point Bend Test as described in the Society for Information Display (SID) 2011 Digest, pages 652-654, in a paper entitled “Two Point Bending of Thin Glass Substrate” by S. T. Gulati, J. Westbrook, S. Carley, H. Vepakomma, and T. Ono. As described in that document as applied to a solid-state electrolyte sheet, the solid-state electrolyte sheet is placed between a pair of parallel rigid stainless-steel plates of a parallel plate apparatus such that the second major surface 107 of the solid-state electrolyte sheet contacts each plate, and the distance between parallel is decreased until the substrate fails at a parallel plate distance (D). The edge strength o is calculated as σ=1.198 Et/(D−t), where E is the elastic modulus of the solid-state electrolyte sheet and t is the thickness 109 of the solid-state electrolyte sheet. During the Two Point Bend test, the environment was controlled at 50% relative humidity and 25° C., and the parallel plate distance was decreased at a rate of 50 μm/second. As used herein, the terms “fail,” “failure” and the like refer to breakage, destruction, delamination, or crack propagation. Throughout the disclosure, the “B10 edge strength” of the substrate is the mean stress of failure of the substrate where 10% of the samples are expected to fail, and the “median edge strength” of the substrate is the mean stress of failure of the substrate where 50% of the samples are expected to fail. Unless otherwise indicated, “edge strength” refers to the B10 edge strength is measured in the Two-Point Bend Test as described above in this paragraph. In aspects, an edge strength of the solid-state electrolyte sheet 103 can be 300 MegaPascals (MPa) or more, 350 MPa or more, 400 MPa or more, 450 MPa or more, 500 MPa or more, 530 MPa or more, 540 MPa or more, 550 MPa or more, 560 MPa or more, 570 MPa or more, 580 MPa or more, 600 MPa or more, 650 MPa or more, 700 MPa or more, 800 MPa or more, 900 MPa or more, 1200 MPa or less, 1100 MPa or less, 1000 MPa or less, 900 MPa or less, 850 MPa or less, 800 MPa or less, 750 MPa or less, 700 MPa or less, 650 MPa or less, 600 MPa or less, 580 MPa or less, 560 MPa or less, 550 MPa or less, or 500 MPa or less. In aspects, an edge strength of the solid-state electrolyte sheet 103 can be in a range from 300 MPa to 1200 MPa, from 350 MPa to 1200 MPa, from 400 MPa to 1200 MPa, from 450 MPa to 1200 MPa, from 500 MPa to 1200 MPa, from 530 MPa to 1100 MPa, from 540 MPa to 1000 MPa, from 550 MPa to 900 MPa, from 560 MPa to 850 MPa, from 570 MPa to 800 MPa, from 580 MPa to 750 MPa, from 600 MPa to 700 MPa, or any range or subrange therebetween.

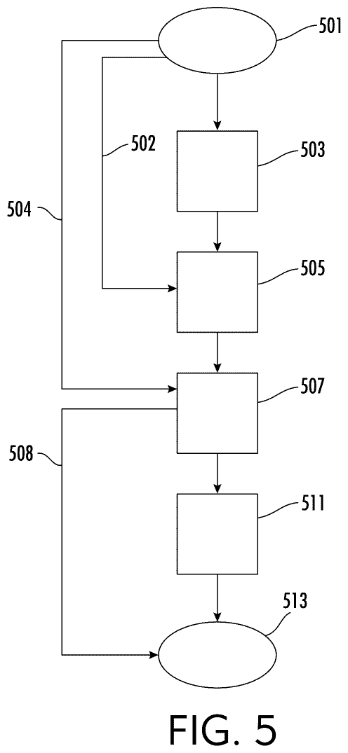

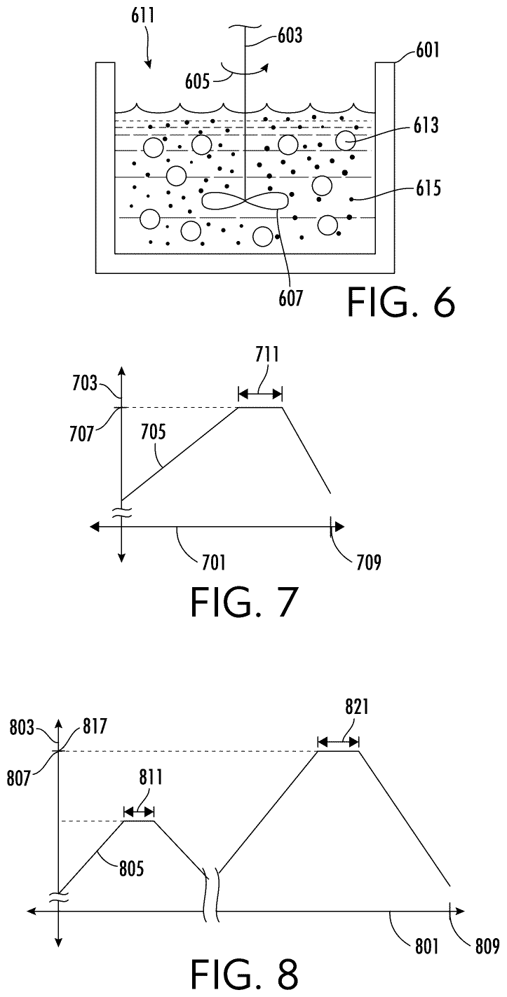

Aspects of methods of making a solid-state electrolyte sheet, a solid oxide electrolyzer cell, and/or a solid oxide fuel cell in accordance with the aspects of the present disclosure will now be discussed with reference to the flow chart shown in FIG. 5 and example method steps illustrated in FIGS. 6-9.

In aspects, as shown in FIG. 5, methods can begin at step 501. In aspects, step 501 can comprise providing or forming a stabilized zirconia. For example, stabilized zirconia can be provided by purchase or the stabilized zirconia can comprise melting raw materials, cooling the melt to form a glass, and then heating the glass to form stabilized zirconia. In aspects, step 501 can additionally comprise providing materials for forming a green tape, for example, a solvent, a binder, a dispersant, and/or a protic base that are discussed more in the following steps. Alternatively, in aspects, step 501 can comprise forming or otherwise providing a green tape comprising stabilized zirconia. The stabilized zirconia (either as a raw material or in a green tape) can comprise scandia within one or more of the corresponding ranges discussed above.

In aspects, after step 501 as shown in FIG. 5, methods can proceed to step 503 comprising forming a slip. In aspects, as shown in FIG. 6, step 503 can comprise mixing raw materials (e.g., stabilized zirconia 613 and/or binder 615) to form a slip 611. For example, as shown, raw materials including stabilized zirconia 613 and/or binder 615 can be mixed with a solvent (and optionally a dispersant, a defoamer, a plasticizer, and/or a protic base) in a container 601 using a blade 607 that is rotated (as shown by arrow 605) about a shaft 603. In aspects, the stabilized zirconia 613 can be added after the other materials and/or the stabilized zirconia 613 can be added as a series of batches, for example, to increase a dispersion (e.g., homogeneity) of the materials in the slip 611. In aspects, an amount of stabilized zirconia in the slip 611 or the cast green tape (as a wt % of the total slip or green tape, respectively) can be 55 wt % or more, 58 wt % or more, 60 wt % or more, 62 wt % or more, 64 wt % or more, 65 wt % or more, 66 wt % or more, 67 wt % or more, 70 wt % or less, 69 wt % or less, 68 wt % or less, 67 wt % or less, 66 wt % or less, 65 wt % or less, 63 wt % or less, or 60 wt % or less. In aspects, an amount of stabilized zirconia in the slip 611 or the cast green tape (as a wt % of the total slip or green tape, respectively) can be in a range from 55 wt % to 70 wt %, from 60 wt % to 70 wt %, from 62 wt % to 69 wt %, from 63 wt % to 68 wt %, from 64 wt % to 67 wt %, from 65 wt % to 66 wt %, or any range or subrange therebetween. In aspects, preferred ranges for the amount of the stabilized zirconia can be from 55 wt % to 70 wt %, from 63 wt % to 68 wt %, or from 64 wt % to 67 wt %, or any range or subrange therebetween.

In aspects, the stabilized zirconia used in the slip 611 (e.g., added to the mixture in step 503 to form the slip 611) can comprise particles with a purity of 95% or more, 97% or more, 98% or more, 99.0% or more, 99.5% or more, or 99.7% or more. For example, the stabilized zirconia used in the slip 611 can comprise 0.1 mol % or less, 0.05 mol % or less, 0.01 mol % or less, or be free of alumina. As used herein, the “specific surface area” is measured in accordance with ASTM C1069-09 (2014). In further aspects, the stabilized zirconia used in the slip 611 (e.g., added to the mixture in step 503 to form the slip 611) can comprise a specific surface area of 10 m²/g or less, 8 m²/g or less, 7 m²/g or less, 3 m²/g or more, 5 m²/g or more, or 6 m²/g or more, for example, in a range from 3 m²/g to 10 m²/g, from 5 m²/g to 8 m²/g, from 6 m²/g to 8 m²/g, or any range or subrange therebetween. As used herein, a particle size distribution (e.g., d10, d50 or median, and d90) is determined in accordance with ASTM D1214-10 (2020). In further aspects, a median particle size (i.e., d50) of the stabilized zirconia used in the slip can be 0.3 μm or more, 0.4 μm or more, 0.5 μm or more, 0.6 μm or more, 1.0 μm or less, 0.9 μm or less, 0.8 μm or less, 0.7 μm or less, 0.6 μm or less, or 0.5 μm or less. In further aspects, a median particle size (i.e., d50) of the stabilized zirconia used in the slip can be in a range from 0.3 μm to 1.0 μm, from 0.3 μm to 0.9 μm, from 0.4 μm to 0.8 μm, from 0.5 μm to 0.7 μm, or any range or subrange therebetween. In further aspects, a d10 particle size of the stabilized zirconia used in the slip can be 0.1 μm or more, 0.2 μm or more, 0.3 μm or more, 0.5 μm or less, 0.4 μm or less, or 0.3 μm or less, for example, in a range from 0.1 μm to 0.4 μm, from 0.2 μm to 0.3 μm, or any range or subrange therebetween. In further aspects, a d90 particle size of the stabilized zirconia used in the slip can be 4.0 μm or less, 3.7 μm or less, 3.5 μm or less, 3.2 μm or less, 3.0 μm or less, 2.0 μm or more, 2.5 μm or more, or 3.0 μm or more, for example, in a range from 2.0 μm to 4.0 μm, from 2.5 μm to 3.7 μm, from 3.0 μm to 3.5 μm, or any range or subrange therebetween. In further aspects, a spread between a d10 particle size and a d90 particle size of the stabilized zirconia used in the slip can be 3.5 μm or less, 3.2 μm or less, 3.0 μm or less, 2.8 μm or less, 2.5 μm or less, 2.2 μm or less, 2.0 μm or less, 1.0 μm or more, 1.5 μm or more, 2.0 μm or more, or 2.2 μm or more, for example, in a range from 1.0 μm to 3.5 μm, from 1.5 μm to 3.2 μm, from 2.0 μm to 3.0 μm, from 2.2 μm to 2.8 μm, or any range or subrange therebetween.

The binder 615 can comprise one or more polymeric materials. The binder can provide mechanical strength to the green tape before and/or during the sintering. In aspects, the binder can be a polymer compatible with the solvent, for example, an acrylic polymer, a methacrylate polymer, a carbonate-containing polymer, a vinyl acetate resin, a maleic acid polymer, a vinyl butyral resin, a vinyl formal resin, a vinyl alcohol resin, a cellulose resin, or copolymers or combinations thereof. An exemplary aspect of the binder is an acrylic polymer system, which are commercially available from numerous polymer and casting companies. In aspects, an amount of the binder in the slip 611 or the cast green tape (as a wt % of the total slip or green tape, respectively) can be 10 wt % or more, 11 wt % or more, 12 wt % or more, 12.5 wt % or more, 13 wt % or more, 13 wt % or more, 13.5 wt % or more, 15 wt % or less, 14.5 wt % or less, 14 wt % or less, 13.5 wt % or less, 13 wt % or less, or 12.5 wt % or less. In aspects, an amount of the binder in the slip 611 or the cast green tape (as a wt % of the total slip or green tape, respectively) can be in a range from 10 wt % to 15 wt %, from 11 wt % to 14.5 wt %, from 12 wt % to 14 wt %, from 12.5 wt % to 14 wt %, from 13 wt % to 13.5 wt % or any range or subrange therebetween. In aspects, preferred ranges for the amount of the binder can be from 10 wt % to 15 wt %, from 12 wt % to 14.5 wt %, or from 13 wt % to 14 wt %, or any range or subrange therebetween.

In aspects, the solvent can be a polar protic solvent, for example water or alcohols (e.g., methanol, ethanol, isopropyl alcohol, acetic acid), or a polar aprotic solvent, for example a ketone (e.g., methyl ethyl ketone, acetone), N,N-dimethylformamide, dimethyl sulfoxide, dimethyl sulfoxide, dimethyl carbonate, methyl ethyl ketone, toluene, anisole, dioxolane, methoxy propyl acetate, or combinations thereof. An exemplary aspect of the solvent is water. In aspects, an amount of the solvent in the slip 611 or the cast green tape (as a wt % of the total slip or green tape, respectively, before the solvent is evaporated) can be 10 wt % or more, 15 wt % or more, 16 wt % or more, 17 wt % or more, 18 wt % or more, 19 wt % or more, 20 wt % or more, 22 wt % or more, 30 wt % or less, 25 wt % or less, 23 wt % or less, 22 wt % or less, 21 wt % or less, 20 wt % or less, or 19 wt % or less. In aspects, an amount of the solvent in the slip 611 or the cast green tape (as a wt % of the total slip or green tape, respectively, before the solvent is evaporated) can be in a range from 10 wt % to 30 wt %, from 15 wt % to 25 wt %, from 16 wt % to 23 wt %, from 17 wt % to 22 wt %, from 18 wt % to 21 wt %, from 19 wt % to 20 wt %, or any range or subrange therebetween.

As used herein, a “dispersant” refers to a material that improves a separation of particles, improves a uniformity of a distribution of particles, decreases particle aggregation, and/or reduces settling of particles. In aspects, the dispersant can comprise a fish oil or commercial dispersants, for example, the Hypermer line of dispersants (available from Croda Energy Technologies). In aspects, an amount of the dispersant in the slip 611 or the cast green tape (as a wt % of the total slip or green tape, respectively) can be 0 wt % or more, 0.1 wt % or more, 0.2 wt % or more, 0.5 wt % or more, 0.7 wt % or more, 1.0 wt % or more, 1.2 wt % or more, 1.5 wt % or more, 5 wt % or less, 4 wt % or less, 3 wt % or less, 2 wt % or less, 1.5 wt % or less, or 1 wt % or less. In aspects, an amount of the dispersant in the slip 611 or the cast green tape (as a wt % of the total slip or green tape, respectively, before the solvent is evaporated) can be in a range from 0 wt % to 5 wt %, from 0.1 wt % to 5 wt %, from 0.2 wt % to 4 wt %, from 0.5 wt % to 3 wt %, from 0.7 wt % to 2 wt %, from 1 wt % to 1.5 wt %, or any range or subrange therebetween. Providing a dispersant can facilitate a good dispersion of stabilized zirconia particles in the solvent with few or no aggregates.

As noted above, additional components in the slip 611 can include a defoamer and/or a plasticizer. For example, plasticizers can include a dibutyl carboxylic acid ester. Exemplary aspects of plasticizers include dibutyl phthalate, dibutyl adipate, dibutyl maleate, poly(ethylene glycol), and combinations thereof. In further aspects, the viscosity modifier can comprise dibutyl phthalate. Amounts of the additional components can be within one or more of the range discussed above in the previous paragraph for the amount of the dispersant. Alternatively, in aspects, the slip 611 can be free from a defoamer, a plasticizer, and/or other additional components.

Without wishing to be bound by theory, a protic base can passivate and/or form a hydroxide compound at a surface of the stabilized zirconia. In aspects, the protic base can be an alkali hydroxide (e.g., NaOH, KOH) and/or ammonia. An exemplary aspect of the protic base is ammonia. In aspects, an amount of the protic base (or reaction products thereof) in the slip 611 or the cast green tape (as a wt % of the total slip or green tape, respectively) can be 0 wt % or more, 0.1 wt % or more, 0.2 wt % or more, 0.5 wt % or more, 0.7 wt % or more, 1.0 wt % or more, 1.2 wt % or more, 1.5 wt % or more, 5 wt % or less, 4 wt % or less, 3 wt % or less, 2 wt % or less, 1.5 wt % or less, or 1 wt % or less. In aspects, an amount of the protic base (or reaction products thereof) in the slip 611 or the cast green tape (as a wt % of the total slip or green tape, respectively, before the solvent is evaporated) can be in a range from 0 wt % to 5 wt %, from 0.1 wt % to 5 wt %, from 0.2 wt % to 4 wt %, from 0.5 wt % to 3 wt %, from 0.7 wt % to 2 wt %, from 1 wt % to 1.5 wt %, or any range or subrange therebetween.

In aspects, although not shown, step 503 can further comprise deairing the slip. In further aspects, deairing the slip can comprise subjecting the slip to a reduced pressure environment for a predetermined period of time. As used herein, a “reduced pressure environment” has an absolute pressure of less than 80 kiloPascals (kPa). In further aspects, the reduced pressure environment can comprise an absolute pressure in a range from 1 kPa to 80 kPa, from 5 kPa to 50 kPa, from 10 kPa to 30 kPa, or any range or subrange therebetween. In further aspects, the predetermined period of time can be 1 minute or more, 5 minutes or more, 30 minutes or less, or 10 minutes or less, for example, from 1 minute to 30 minutes, from 5 minutes to 10 minutes, or any range or subrange therebetween.

After step 501 or 503, as shown in FIG. 5, methods can proceed to step 505 comprising casting the slip 611 to form a green tape with an initial thickness. In further aspects, the initial thickness can be within one or more of the ranges discussed above for the thickness 109. In further aspects, the initial thickness can be greater than the thickness 109 of the resulting solid-state electrolyte sheet 103 by from 1% to 50%, from 2% to 40%, from 5% to 30%, from 7% to 20%, from 10% to 15%, or any range or subrange therebetween. In further aspects, casting can comprise using a doctor blade or other methods known in the art.

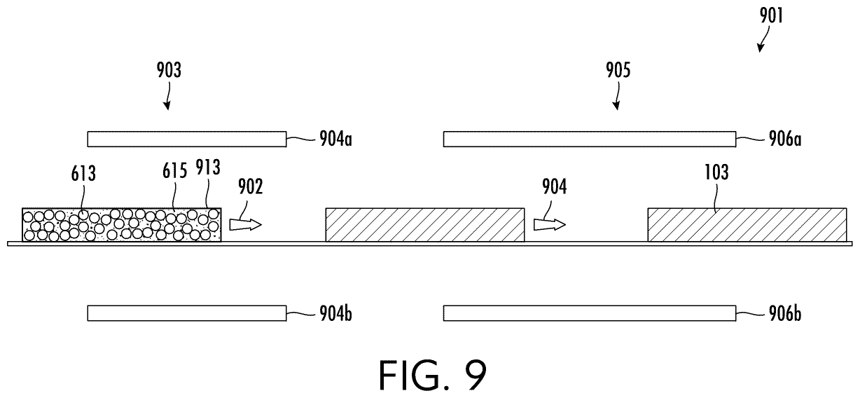

After step 501 or 505, as shown in FIG. 5, methods can proceed to step 507 comprising firing the green tape to form the solid-state electrolyte sheet 103. In aspects, as shown in FIG. 9, step 507 comprises heating a green tape 913 (comprising the stabilized zirconia 613 and the binder 615) with one or more heaters 904a and/or 904b (e.g., in a first oven 903 as part of a firing apparatus 901). In further aspects, as shown, the green tape can be conveyed through the first oven 903 (e.g., one or more heaters 904a and/or 904b) in a direction 902. In even further aspects, the green tape can be conveyed on a setter plate, although long green tapes can be conveyed through using a rollers system spanning a distance greater than the first oven 903. Heating the green tape can remove organic materials (e.g., solvent and/or binder) in the green tape. Additionally, heating the green tape can sinter the stabilized zirconia in the green tape to form the solid-state electrolyte sheet 103. Additionally, after the heating, the heated green tape (referred to as a “sintered tape” for clarity) is then quenched (as discussed below) to form the solid-state electrolyte sheet. As discussed herein, the inventors unexpectedly discovered that quenching (e.g., from a temperature of 500° C. or more, from a temperature in a range from 600° C. to 1000° C.) can impact the resulting crystal structure(s) of the resulting solid-state electrolyte sheet and provide unexpectedly improved ionic conductivity. Consequently, it has been unexpectedly observed that increasing the amount of cubic phase in the stabilized zirconia grains can increase ionic conductivity.

In aspects, the firing can comprise heating the green tape at a maximum temperature of 1650° C. or less, 1625° C. or less, 1600° C. or less, 1575° C. or less, 1550° C. or less, 1525° C. or less, 1500° C. or less, 1450° C. or less, or 1400° C. or less. In aspects, the firing can comprise heating the green tape at a maximum temperature in a range from 1100° C. to 1650° C., 1200° C. to 1600° C., from 1300° C. to 1575° C., from 1350° C. to 1550° C., from 1375° C. to 1500° C., from 1400° C. to 1475° C., from 1425° C. to 1450° C., or any range or subrange therebetween. Throughout the disclosure, heating “at” a specified temperature means that the heating provided from the local environment (e.g., heaters, oven) are maintained to provide a local temperature at the specified temperature. Providing a maximum temperature of 1650° C. or less (or 1625° C. or less or 1600° C. or less) can facilitate formation of the microstructure (e.g., grain size, porosity, and/or associated grain size distribution) associated with the increased ionic conductivity of the solid-state electrolyte sheets of the present disclosure.

In aspects, the firing can comprise heating the green tape at temperatures of 600° C. or more (e.g., from 600° C. to the maximum temperature; or 1000° C. or more, 1200° C. or more, or 1300° C. or more) for 90 minutes or less, 75 minutes or less, 60 minutes or less, 50 minutes or less, 45 minutes or less, 40 minutes or less, 35 minutes or less, 30 minutes or less, 25 minutes or less, 20 minutes or less, 15 minutes or less, 10 minutes or less, 2 minutes or more, 3 minutes or more, 5 minutes or more, 7 minutes or more, 10 minutes or more, 12 minutes or more, 15 minutes or more, 17 minutes or more, 20 minutes or more, 25 minutes or more, or 30 minutes or more. In aspects, the firing can comprise heating the green tape at temperatures of 600° C. or more (e.g., from 600° C. to the maximum temperature) for a period of time in a range from 2 minutes to 90 minutes, from 3 minutes to 75 minutes, from 5 minutes to 60 minutes, from 7 minutes to 50 minutes, from 10 minutes to 45 minutes, from 12 minutes to 40 minutes, from 15 minutes to 35 minutes, from 17 minutes to 30 minutes, from 20 minutes to 25 minutes, or any range or subrange therebetween. Consequently, the time that the green tape is heated at temperature of 1300° C. (and likewise for 1000° C. or more or 1200° C. or more; e.g., from 1300° C. to the maximum temperature) can be within one or more of the ranges mentioned above in this paragraph. Heating the green tape (at temperatures of 600° C. or more, 1000° C. or more, 1200° C. or more, or 1300° C. or more) for 90 minutes or less (e.g., from 5 minutes to 60 minutes) can reduce resource requirements and/or increase a throughput of the method.

In aspects, the heating portion of the firing can comprise exposing the green tape to a heating temperature profile, which can resemble the temperature profiles 705 or 805 schematically shown in FIGS. 7-8. In FIGS. 7-8, the horizontal axis 701 or 801 (e.g., x-axis) corresponds to time and the vertical axis 703 and 803 (e.g., y-axis) corresponds to a temperature that the green tape is heated at. For example, the temperature profiles 705 or 805 shown in FIGS. 7-8 can be achieved by conveying the green tape through an oven (e.g., lehr) with spatially distinct zones maintained at various temperatures to approximate the temperature profile. Consequently, it is to be understood that temperature profiles may be a series of temperature steps rather than the linear temperature ramps shown in FIGS. 7-8. As shown in FIGS. 7-8, the period of time for heating the green tape at temperatures of 600° C. or more discussed in the previous paragraph can correspond to time 807 or 809.

Throughout the disclosure, a “firing step” refers to heating at temperatures greater than 600° C. that increases by more than 200° C. to reach a local maximum temperature before decreasing by more than 200° C. In further aspects, as shown in FIG. 7, the temperature profile 705 (e.g., firing) can comprise a single firing step to the maximum temperature 707. For example, a single firing step can remove organic materials and sinter the green tape, although organic materials can be removed at a temperature lower than 600° C. before the single firing step in further aspects. Alternatively, in further aspects as shown in FIG. 8, the temperature profile 805 (e.g., firing) can comprise a plurality of firing steps (i.e., two or more firing steps). For example, as shown in FIG. 8, the temperature profile 805 can have two firing steps, for example, heating to a local maximum temperature 811 in a first firing step followed by heating to the maximum temperature 821 in a second firing step. As shown in FIG. 9, after heating the green tape 913 in the first oven 903 (e.g., heaters 904a and/or 904b) corresponding to a first firing step (as indicated by the green body being conveyed therethrough in direction 902), the resulting article can be further heated in a second oven 905 (e.g., heaters 906a and/or 906b) in a second firing step (as indicated by arrow 904).

In further aspects, with reference to FIGS. 7-8, a maximum period of time that the maximum temperature 711 or 821 (as part of a temperature ramp to the maximum temperature in a firing step) that the green tape is exposed to can be 20 minutes or less, 17 minutes or less, 15 minutes or less, 12 minutes or less, 10 minutes or less, 7 minutes or less, 5 minutes or less, or 3 minutes or less. In further aspects, with reference to FIGS. 7-8, a maximum period of time that the maximum temperature 711 or 821 (as part of a temperature ramp to the maximum temperature in a firing step) that the green tape is exposed to can be in a range from 10 seconds to 20 minutes, from 20 seconds to 17 minutes, from 30 minutes to 15 minutes, from 45 seconds to 12 minutes, from 1 minute to 10 minutes, from 2 minutes to 7 minutes, from 3 minutes to 5 minutes, or any range or subrange therebetween. In further aspects, with reference to FIGS. 7-8, a maximum period of time that the maximum temperature 711 or 821 (as part of a temperature ramp to the maximum temperature in a firing step), as a percentage of the period of time in the firing step at temperatures of 600° C. or more, that the green tape is exposed to can be 1% or more, 3% or more, 5% or more, 7% or more, 10% or more, 12% or more, 15% or more, 20% or less, 17% or less, 15% or less, 12% or less, 10% or less, 7% or less, or 5% or less. In further aspects, with reference to FIGS. 7-8, a maximum period of time that the maximum temperature 711 or 821 (as part of a temperature ramp to the maximum temperature in a firing step), as a percentage of the period of time in the firing step at temperatures of 600° C. or more, that the green tape is exposed to can be in a range from 1% to 20%, from 3% to 20%, from 5% to 20%, from 7% to 17%, from 10% to 15%, or any range or subrange therebetween. In further aspects, a maximum total period of time that maximum temperatures 711 or 811 and 821 (either in absolute time or as a percentage of the period of time in the firing step at temperatures of 600° C. or more) can be within one or more of the corresponding ranges discussed above in this paragraph for the maximum period of time at the maximum temperature. Providing a maximum period of time at the maximum temperature from 10 seconds to 20 minutes or from 5% to 20% of the period of time in the firing step at temperatures of 600° C. or more can reduce resource requirements (e.g., energy) of the method.

After heating the green tape to obtain a sintered tape, the firing of step 507 further comprises quenching the sintered tape from at least a starting temperature to final temperature. In aspects, the quenching can occur after a single firing step (i.e., the firing consists of a single firing step to the maximum temperature followed by the quenching). Alternatively, the quenching can occur at end of (e.g., after) multiple firing steps (discussed above). In aspects, the starting temperature for the quenching can be at least 500° C., for example, 500° C. or more, 550° C. or more, 600° C. or more, 625° C. or more, 650° C. or more, 675° C. or more, or 700° C. or more, 750° C. or more, 800° C. or more, 850° C. or more, 900° C. or more, the maximum temperature of the heating or less, 1300° C. or less, 1200° C. or less, 1100° C. or less, 1000° C. or less, 950° C. or less, 900° C. or less, 850° C. or less 800° C. or less, 750° C. or less, 700° C. or less, 650° C. or less, or 600° C. or less. In aspects, the starting temperature for the quenching can be in a range from 500° C. to the maximum temperature of the heating, from 500° C. to 1300° C., from 550° C. to 1200° C., from 550° C. to 1100° C., from 600° C. to 1000° C., from 600° C. to 950° C., from 625° C. to 900° C., from 650° C. to 850° C., from 675° C. to 800° C., from 700° C. to 750° C., or any range or subrange therebetween. In preferred aspects, the starting temperature for the quenching can be from 500° C. to 1300° C., from 600° C. to 1000° C., or from 650° C. to 900° C. In aspects, the final temperature of the quenching can be less than 100° C., for example, less than 100° C., 60° C. or less, 40° C. or less, 30° C. or less, 25° C. or less, 20° C. or less, 0° C. or more, 10° C. or more, 20° C. or more, or 25° C. or more. In aspects, the final temperature of the quenching can be from 0° C. to less than 100° C., from 10° C. to 60° C., from 20° C. to 40° C., from 25° C. to 30° C., or any range or subrange therebetween. Without wishing to be bound by theory, it is believed that quenching from at least 500° C. can increase an amount of a cubic phase in the stabilized zirconia grains of the solid-state electrolyte sheet. The present inventors believe that it has not been appreciated that that the phase structure at a high temperatures can be largely maintained (e.g., “locked in”) by quenching from the high temperature to a temperature near room temperature (e.g., less than 100° C., from 0° C. to 40° C.).

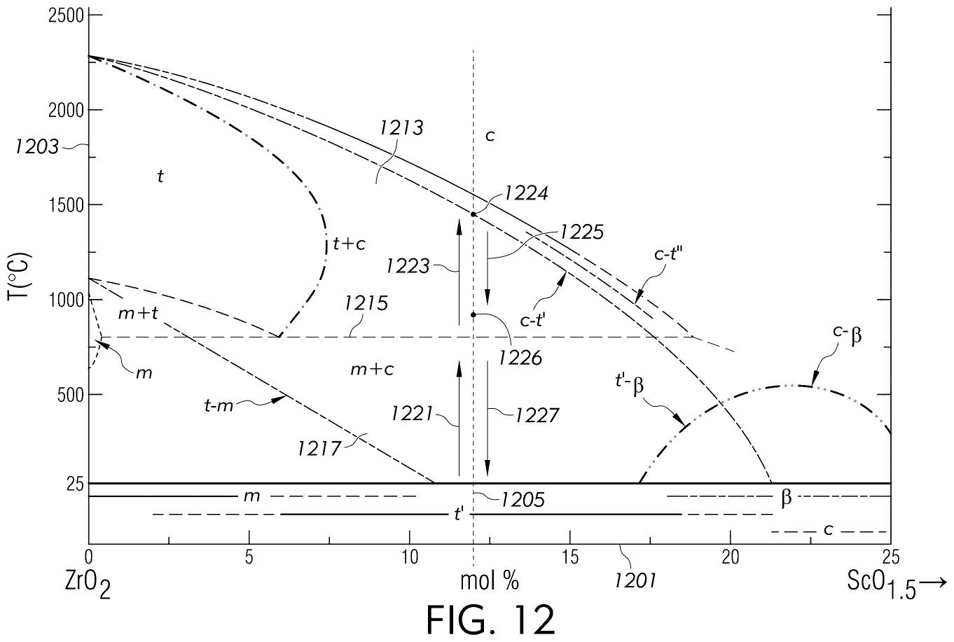

The phase diagram shown in FIG. 12 shows equilibrium crystal phases as a function of amount of dopant (in the case of scandium doping, although the axis values correspond to half of the amount of scandia—i.e., 12 mol % ScO_{1.5} corresponding to 6 mol % scandia (Sc₂O₃)) on the horizontal axis 1201 (i.e., x-axis) and temperature on the vertical 1203 (i.e., y-axis). For 6 mol % dopant (scandia)—corresponding to the dashed line 1205 at 12 mol % ScO_{1.5}—the stabilized zirconia has a mixture of the tetragonal phase and the cubic phase (t+c) above the horizonal dashed line 1215 (e.g., between 650° C. and 1700° C.) in region 1213, including points 1224 and 1226. At low temperature, between the horizonal dashed lined and the solid line (e.g., between 250° C. and 650° C.), there is mixture of the monoclinic phase and the cubic phase (m+c). At even lower temperatures, another tetragonal phase (t′) is formed in region 1217. A conventional firing process (e.g., along dashed line 1205) would heat the sample (arrows 1221 and 1223) at a maximum temperature (e.g., reaching point 1224) followed by gradually cooling the sample (arrow 1225 and 1127), where the phase assemblage of the sample can equilibrate. For example, if the sample is allowed to equilibrate down to temperatures of about 250° C. or less, the t′ tetragonal phase is expected to predominate-largely without the presence of the cubic phase. In contrast, after heating to reach point 1224 (by arrows 1221 and 1223), methods of the present disclosure only allow the sample to equilibrate down to the starting temperature of the quenching (e.g., cooling along arrow 1225 to point 1226); the quenching limits the ability of the phase assemblage in the sample to adjust by kinetically trapping the structure of the sample at the starting temperature (e.g., point 1126). Consequently, the methods of the present disclosure can achieve stabilized zirconia having substantial portions of grains in the cubic phase (e.g., corresponding to point 1226 in the t+c region 1213) since the cubic phase is kinetically trapped.

In aspects, although not shown, the solid-state electrolyte sheet formed in step 507 can be wound (e.g., rolled) on a spool, for example, for storage and/or transport. The thin form factor (e.g., thickness) and high edge strength enable the solid-state electrolyte sheet to be wound on the spool. In further aspects, the solid-state electrolyte sheet can be unwound from the spool and cut to a predetermined size based on the resulting solid oxide fuel cell and/or a solid oxide electrolyzer cell that it is to be incorporated into, for example, in step 511.

In aspects after step 507, as shown in FIG. 5, methods can proceed to step 511 comprising assembling the solid-state electrolyte sheet into a solid oxide fuel cell and/or a solid oxide electrolyzer cell (e.g., see FIGS. 1-2). In further aspects, step 507 can comprise disposing an oxygen electrode over the first major surface of the solid-state electrolyte sheet and a fuel electrode over the second major surface opposite the first major surface. In further aspects, with reference to FIG. 1, step 507 can comprise disposing the assembly of the oxygen electrode 113, the solid-state electrolyte sheet 103, and the fuel electrode 123 in a body 151 including an oxygen-containing region 153 and/or a fuel-containing region 155.

After step 507 or 511, methods can be complete upon reaching step 513. In aspects, methods of making the making the solid-state electrolyte sheet, the solid oxide electrolyzer cell, and/or the solid oxide fuel cell with aspects of the disclosure can proceed along steps 501, 503, 505, 507, 511, and 513 of the flow chart in FIG. 5 sequentially, as discussed above. In aspects, methods can follow arrow 502 from step 501 to step 505, for example, if a slip is already present by the end of step 501. In aspects, methods can follow arrow 504 from step 501 to step 505, for example, if a green tape is already present by the end of step 501. In aspects, methods can follow arrow 508 from step 507 to step 513, for example, if methods are complete at the end of step 507. Any of the above options may be combined to make the solid-state electrolyte sheet, the solid oxide electrolyzer cell, and/or the solid oxide fuel cell with aspects of the disclosure.

### Examples

Various aspects will be further clarified by the following examples. Comparative Examples comprised yttria-stabilized zirconia with 3 mol % yttria (“YSZ”). Comparative Example CC comprised stabilized zirconia with 6 mol % scandia not manufactured in accordance with the present disclosure. Examples 1-26 and D-F comprised scandia-stabilized zirconia with 6 mol % scandia that is manufactured in accordance with the present disclosure.

The slip for Examples 1-24 and D-F was prepared by milling a solvent, a binder, a dispersant, a protic base, and a defoamer with YSZ milling media. The 6 mol % scandia-stabilized zirconia comprising a specific surface area of 7.5 m²/g and a median particle size of 0.78 μm was added to this mixture to form the slip in accordance with the present disclosure, as described above. The slip was then deaired for 1 hour under vacuum. The green tape was cast to a thickness of about 50 μm at about 23° C. and about 50% relative humidity. The green tape was fired using the firing profiles detailed in Tables 1 and 4. For Examples 1-24 and D-F, the solvent was water, the binder was an acrylic polymer system, and the protic base was ammonia.

Comparative Examples AA-BB manufactured using the same method as outlined above for Examples 1-24 except that (1) YSZ was used instead of scandia-stabilized zirconia and (2) the composition of the slip in w % was adjusted to have the same vol % of components as Examples 1-24 (due to differences in the density of scandia-stabilized zirconia and YSZ). Comparative Example CC was prepared as reported in Mark R. Terner et al, “On the conductivity degradation and phase stability of solid oxide fuel cell (SOFC) zirconia electrolytes analyzed via XRD”, Solid State Ionics 263 (2014): 180-189.

Table 1 presents the firing profiles for Examples 1-11 and Comparative Examples (Comp. Ex.) AA-BB. As shown, the firing profiles for Examples 1-11 and Comparative Examples AA-BB have two firing steps (e.g., see FIG. 8). The first firing step had a local maximum temperature (max T₁) of from 1380° C. to 1400° C. for from 1 minute to 1.5 minutes with a total heating time for the first firing step of 9 minutes. Examples 1-5 have the same first firing step times and temperatures as one another; likewise, Examples 6-11 have the same first firing step times and temperatures as one another but different from those for Examples 1-5. The second firing step had a maximum temperature (max T₂) of from 1560° C. to 1625° C. for from 0.25 minutes (15 seconds) to 12 minutes with a total heating time for the second firing step of 2.25 minutes (2 minutes and 15 seconds) to 24 minutes. In Examples 1-5 (and Examples 6-11, respectively) the maximum temperature is the same but the time at the maximum temperature decreases going from Example 1 to Example 5 (or from Example 6 to Example 11) and the maximum temperature for Examples 1-6 is different than the maximum temperature for Examples 6-11. As shown in Table 1, the total heating time is from about 11 minutes to about 50 minutes.

TABLE 1
Firing Profiles of Examples 1-11
and Comparative Examples AA-BB

| | | | | | Total |
|---|---|---|---|---|---|
| | Max | Time at | Max | Time at | Heating |
| | T₁ | T₁ | T₂ | T₂ | Time |
| | (° C.) | (min) | (° C.) | (min) | (min) |
| Comp. Ex. AA | 1400 | 1 | 1566 | 1 | 18 |
| Comp. Ex. BB | 1380 | 1.5 | 1566 | 3 | 33 |
| Example 1 | 1400 | 1 | 1625 | 2 | 27 |
| Example 2 | 1400 | 1 | 1625 | 1 | 18 |
| Example 3 | 1400 | 1 | 1625 | 0.5 | 13.5 |
| Example 4 | 1400 | 1 | 1625 | 0.33 | 12 |
| Example 5 | 1400 | 1 | 1625 | 0.25 | 11.25 |
| Example 6 | 1380 | 1.5 | 1566 | 12 | 82.5 |
| Example 7 | 1380 | 1.5 | 1566 | 6 | 49.5 |
| Example 8 | 1380 | 1.5 | 1566 | 3 | 33 |
| Example 9 | 1380 | 1.5 | 1566 | 1.5 | 24.75 |
| Example 10 | 1380 | 1.5 | 1566 | 1 | 22 |
| Example 11 | 1380 | 1.5 | 1566 | 0.75 | 20.63 |

TABLE 2
Microstructure of Examples 1-11
and Comparative Examples AA-BB

| | Porosity | Min Grain | Mean Grain | Max Grain |
|---|---|---|---|---|
| | (%) | Size (μm) | Size (μm) | Size (μm) |
| Comp. Ex. AA | 0.05 | 0.31 | 0.40 | 0.50 |
| Comp. Ex. BB | 0.09 | 0.31 | 0.39 | 0.50 |
| Example 1 | 0.20 | 1.25 | 2.08 | 4.99 |
| Example 2 | 0.58 | 1.25 | 2.08 | 4.99 |
| Example 3 | 1.30 | 1.25 | 1.55 | 2.49 |
| Example 4 | 2.17 | 1.25 | 1.87 | 2.49 |
| Example 5 | 2.74 | 1.25 | 1.31 | 2.49 |
| Example 6 | 0.22 | 1.00 | 1.56 | 2.49 |
| Example 7 | 0.48 | 1.00 | 1.19 | 1.66 |
| Example 8 | 1.16 | 0.71 | 1.04 | 1.66 |
| Example 9 | 2.08 | 0.83 | 1.03 | 1.66 |
| Example 10 | 3.23 | 0.71 | 0.92 | 1.25 |
| Example 11 | 3.97 | 0.62 | 0.80 | 1.00 |

Table 2 presents properties of the microstructure measured for Comparative Examples AA-BB and Examples 1-11, measured as described above. Compared to Comparative Examples AA-BB with less than 0.1% porosity, Examples 1-11 have higher porosity of from about 0.2% to about 4%. Within Examples 1-11, Examples 1-2 and 6-7 have porosity less than 1% and have the longest heating times (and times at the maximum temperature) of Examples 1-11. Consequently, Table 2 suggests that the porosity decreases as the heating time (and time at the maximum temperature) is increased (e.g., going from Example 5 to Example 1 or from Example 11 to Example 5). This suggests that additional heating time (and time at the maximum temperature) facilitates the consolidation of scandia-stabilized grains, which can decrease porosity in the resulting article.

Compared to Comparative Examples AA-BB with a mean grain size of about 0.40 μm, Examples 1-11 have higher mean grain sizes from 0.8 μm to 2.1 μm. Looking at Examples 6-11, the average grain size increases going from Example 11 to Example 6, suggesting that the mean grain size increases as the heating time (and the time at the maximum temperature) increases. This is consistent with the trend in porosity, where the additional heating time (and time at the maximum temperature) facilitates the consolidation of scandia-stabilized grains and thus larger grains. However, Example 4 does not follow this trend. Also, Examples 1-2 have the same measured mean grain size (and distribution as indicated by the minimum and maximum grain sizes), which suggests that there is no further benefit in grain size (although porosity further decreases) by extending the heating conditions from Example 2 to those in Example 1 (even though the time at the maximum temperature is greater for Examples 6-7 than for Examples 1-5).

Table 2 also reports minimum (“min”) and maximum (“max”) grain sizes that can provide a sense of the grain size distribution (e.g., in combination with the mean grain size). The maximum grain size decreases going from Example 1 to Example 11. Examples 1-2, 3-6, and 7-9 have the same maximum grain size, respectively. Likewise, the minimum grain size decreases from Example 1 to Example (with the exception of Example 9) with Examples 1-5 and 6-7 having the same minimum grain size, respectively. In view of the trends discussed in the previous paragraphs, this is unexpected (especially between Examples 1-5 and Example 6-11) since the lower maximum temperature (max T₂) for Examples 6-11 is lower than that for Examples 1-5. This suggests that slightly longer times (but still less than a total of 60 minutes and a time of less than 20 minutes at the maximum temperature) at a lower maximum temperature can provide decreased grain sizes (e.g., maximum grain size, minimum grain size, and/or mean grain size).

FIGS. 10-11 present results of X-ray diffraction (XRD) analysis of Example 6. As discussed above, in FIGS. 10-11, the horizontal axis 1001 or 1101 (e.g., x-axis) corresponds to two theta (2θ) in degrees (°), and the vertical axis 1003 or 1103 is a relative intensity of the diffraction peaks that is proportional to a number of detected diffracted X-rays. In FIG. 10, spectrum 1005 shows several diffraction peaks that are all associated with the tetragonal crystal phase. Consequently, spectrum 1005 indicates that greater than 99% (e.g., about 100%) of the crystal phases in the scandia-stabilized zirconia grains is tetragonal. In FIG. 11, additional sampling was performed and the zoomed-in portion of the spectrum 1105 shows two peaks that can be fit using curves centered at the locations shown, where curves 1107a-1107c are associated with the tetragonal crystal phase and curves 1109a-b are associated with a cubic zirconia crystal phase. In combination with the other diffraction peaks (including those outside of the zoomed-in range shown in FIG. 11), a relative amount of the tetragonal crystal phase in the scandia-stabilized zirconia grains is still estimated to be 99% or more.

Table 3 presents ionic conductivity values measured at various temperatures (as indicated by the column labels) as well as the edge strength and curvature-related measurements (e.g., TIR and curvature). As described above, ionic conductivity is measured with the 4-point probe. The ionic conductivity of Examples 1-11 is more than three times greater than the corresponding ionic conductivity of Comparative Examples 1-11 (for measurements compared within each of the temperatures reported in Table 3). This is a notable benefit of adding scandia to zirconia instead of yttria in the YSZ of Comparative Examples AA-BB. Further, compared to the scandia-stabilized zirconia of Comparative Example CC, Examples 1-11 exhibit even higher ionic conductivity at 850° C. (e.g., at least 5% greater than Comparative Example CC with Examples 1, 3, and 6-8 exhibiting ionic conductivity of greater than 10 S/m—a 10% or more increase relative to Comparative Example CC). At 900° C., the ionic conductivity of Examples 1-11 are greater than the ionic conductivity of Comparative Example CC (e.g., 30% or more, with Examples 3-4, 6-8, and 10 having an ionic conductivity greater than 13.8 S/m—a 35% or more increase relative to Comparative Example C). Given that Comparative Example CC and Examples 1-11 have the same amount of scandia, this increase in ionic conductivity is unexpected. As discussed above, it is believed that the microstructure (e.g., mean grain size and/or grain size distribution), porosity, and/or closed porosity of Examples 1-11 (and Examples 1-24) facilitate this unexpectedly increased ionic conductivity.

TABLE 3
Ionic Conductivity and Properties of Examples
1-11 and Comparative Examples AA-CC

| Ionic | | | | | Edge | | |
|---|---|---|---|---|---|---|---|
| Conductivity | | | | | Strength | TIR | Curvature |
| (S/m) | 800° C. | 850° C. | 900° C. | 950° C. | (MPa) | (mm) | (D) |
| Comp. Ex. AA | 1.58 | 2.36 | 3.40 | 4.74 | 1006 | 0.75 | 3.3 |
| Comp. Ex. BB | 1.56 | 2.31 | 3.31 | 4.60 | 1034 | 0.27 | 5.3 |
| Comp. Ex. CC | — | 9.10 | 10.20 | — | — | — | — |
| Example 1 | 7.03 | 10.16 | 14.20 | 19.28 | 572 | 0.75 | 2.8 |
| Example 2 | 6.82 | 9.84 | 13.74 | 18.64 | 555 | 0.87 | 2.9 |
| Example 3 | 6.96 | 10.00 | 13.91 | 18.79 | 513 | 0.79 | 3.2 |
| Example 4 | 6.88 | 9.92 | 13.84 | 18.76 | 383 | 0.86 | 5.8 |
| Example 5 | 6.87 | 9.82 | 13.59 | 18.28 | 321 | 1.05 | 11.5 |
| Example 6 | 6.98 | 10.09 | 14.11 | 19.17 | 551 | 0.49 | 7.6 |
| Example 7 | 6.97 | 10.08 | 14.09 | 19.12 | 541 | 0.56 | 6.8 |
| Example 8 | 6.97 | 10.09 | 14.13 | 19.22 | 475 | 0.44 | 5.9 |
| Example 9 | 6.95 | 9.90 | 13.65 | 18.29 | 460 | 0.32 | 5.2 |
| Example 10 | 6.74 | 9.81 | 13.81 | 18.88 | — | 1.40 | 6.6 |
| Example 11 | 6.89 | 9.88 | 13.59 | 18.50 | — | 2.20 | 6.8 |

As shown in Table 3, the edge strength (measured in the Two-Point Bend Test described above) of Examples 1-9 is less than that of Comparative Examples AA-BB. This is expected since increasing amounts of scandia are associated with decreased edge strength and other mechanical properties. However, Examples 1-3 and 6-7 have edge strength greater than 500 MPa, suggesting that increased heating times are associated with increased edge strength.

As shown in Table 3, curvature-related properties are also reported. Examples 1˜4 and 6-9 have a TIR of less than 1 mm (e.g., less than 0.9 mm), which is comparable to or better than the TIR of Comparative Example AA. Similarly, Examples 1˜4 and 6-11 have curvature of less than 10 D (e.g., less than 7 D). Further Examples 1-3 have curvature less than that of Comparative Examples AA-BB. Consequently, methods of present disclosure can produce substantially flat solid-state electrolyte sheets.

Table 4 presents the firing profiles for Examples 12-24 and Examples D-F. In contrast to the firing profiles in Table 1, the firing profiles in Table 4 (for Examples 12-24 and Examples D-F) have a single firing step (e.g., see FIG. 7). Further, compared to the firing profiles in Table 1, the maximum temperature of the firing profile in Table 4 is lower. The single firing step had a maximum temperature (Tₘₐₓ) of from 1450° C. to 1500° C. for from 1.5 minutes to 9 minutes with a total heating time for the single firing step of 5.5 minutes to 33 minutes. In Examples 12-19 (and Examples 20-24, respectively) the maximum temperature is the same but the time at the maximum temperature decreases going from Example 12 to Example 15 and from Example 16 to Example 19 (or from Example 20 to Example 22), and the maximum temperature for Examples 12-19 is different than the maximum temperature for Examples 20-24). Compared to Examples 12-15, Examples 16-20 have the same total heating time (respectively) but Examples 16-20 have more time at the maximum temperature than Examples 12-15 (respectively).

TABLE 4
Firing Profiles of Examples 12-24 and C-E

| | Tₘₐₓ | Time at | Total Heating |
|---|---|---|---|
| | (° C.) | Tₘₐₓ (min) | Time (min) |
| Example 12 | 1500 | 9 | 33 |
| Example 13 | 1500 | 4.5 | 16.5 |
| Example 14 | 1500 | 2.25 | 8.25 |
| Example 15 | 1500 | 1.5 | 5.5 |
| Example 16 | 1500 | 12 | 33 |
| Example 17 | 1500 | 6 | 16.5 |
| Example 18 | 1500 | 3 | 8.25 |
| Example 19 | 1500 | 2 | 5.5 |
| Example 20 | 1450 | 9 | 33 |
| Example 21 | 1450 | 4.5 | 16.5 |
| Example 22 | 1450 | 2.25 | 8.25 |
| Example 23 | 1450 | 12 | 33 |
| Example 24 | 1450 | 6 | 16.5 |
| Example D | 1450 | 1.5 | 5.5 |
| Example E | 1450 | 3 | 8.25 |
| Example F | 1450 | 2 | 5.5 |

TABLE 5
Microstructure of Examples 12-24 and C-E

| | Porosity | Min Grain | Mean Grain | Max Grain |
|---|---|---|---|---|
| | (%) | Size (μm) | Size (μm) | Size (μm) |
| Example 12 | 0.52 | 0.62 | 0.78 | 1.25 |
| Example 13 | 1.32 | 0.55 | 0.73 | 1.25 |
| Example 14 | 2.48 | 0.55 | 0.71 | 1.00 |
| Example 15 | 3.85 | 0.55 | 0.70 | 0.83 |
| Example 16 | 0.48 | 0.71 | 0.86 | 1.66 |
| Example 17 | 1.02 | 0.62 | 0.83 | 1.00 |
| Example 18 | 2.45 | 0.50 | 0.69 | 0.83 |
| Example 19 | 3.37 | 0.55 | 0.68 | 1.00 |
| Example 20 | 0.96 | 0.71 | 0.89 | 1.25 |
| Example 21 | 1.89 | 0.62 | 0.76 | 1.25 |
| Example 22 | 3.76 | 0.55 | 0.63 | 0.83 |
| Example 23 | 0.81 | 0.62 | 0.74 | 1.00 |
| Example 24 | 2.33 | 0.55 | 0.66 | 0.83 |
| Example D | 6.04 | 0.50 | 0.63 | 0.71 |
| Example E | 4.33 | 0.50 | 0.61 | 0.71 |
| Example F | 6.08 | 0.55 | 0.61 | 0.71 |

Table 5 presents properties of the microstructure measured for Examples 12-24, measured as described above. Examples 12-24 have less than 4% porosity while Examples D-F have from 4.3% to 6.1% porosity. Examples 12, 16, 20, and 23 have a porosity of less than 1% and have the longest time at the maximum temperature (and longest total heating time of Examples 12-24). This suggests that porosity similar to that of Examples 2-11 (using two firing steps) can be obtained with the one firing step of Examples 12, 16, 20, and 23.

The mean grain size of Examples 12-24 and D-F is from 0.6 μm to 0.9 μm. The grain size of Examples 12-24 is lower than that for Examples 1-9. As discussed above, smaller mean grain sizes are believed to be associated with higher ionic conductivity, so the single firing step of Examples 12-24 is expected to provide comparable or improved ionic conductivity measurements to those of Examples 1-11. The maximum grain size of Examples 12-24 and D-F is from 0.7 μm to 1.7 μm (from 0.8 μm to 1.3 μm for Examples 12-15 and 17-24). Examples 12-15, 17-24, and D-F have lower maximum grain size values than Examples 1-9. The narrower grain size distribution of Examples 12-24 (especially Examples 12-15 and 17-24 with a range of about 0.6 μm or less or +/−75% of the mean grain size—and Examples 14-15 and 17-19 with a range of about 0.5 μm or less or +/−50% of the mean grain size) are also expected to provide increased ionic conductivity.

The slip for Examples 25-26 and G-L was prepared by milling a solvent, a binder, a dispersant, a protic base, and a defoamer with YSZ milling media. The 6 mol % scandia-stabilized zirconia comprising a specific surface area of 7.5 m²/g and a median particle size of 0.78 μm was added to this mixture to form the slip in accordance with the present disclosure, as described above. The slip was then deaired for 1 hour under vacuum. The green tape was cast to a thickness of about 50 μm at about 23° C. and about 50% relative humidity. The green tape was fired using the firing profiles detailed in Table 6. For Examples 25-26 and G-L, the solvent was water, the binder was an acrylic polymer system, and the protic base was ammonia.

Table 6 presents the firing profiles for Examples 25-26 and G-L. As shown, the firing profiles for Examples 25-26 and G-L have a single firing step (e.g., see FIG. 7) to a maximum temperature of 1300° C. or more for at least 5 minutes (i.e., 7.5 minutes)—unlike the two-step firing process in Examples 1-24. The primary difference between Examples 25-26 and G-L is that Examples G-L were batch fired by heating at 10° C./min to the maximum temperature (see Table 6) and gradually cooled to a temperature less than 400° C. whereas Examples 25-26 were quenched from temperature greater than 500° C. Example 25 was also batch fired (like Examples G-L); however, Example 25 was removed from the furnace at a temperature of 650° C. and rapidly cooled from there to ambient temperature (e.g., about 25° C.). Example 26 was conveyed along a path with the heating profile controlled by spatially adjusting the temperature profile along the path. Example 26 was quenched from a temperature of 860° C. to ambient temperature (e.g., about 25° C.).

TABLE 6
Firing Profiles of Examples 25-26 and G-L

| | Max | Time at | Quench |
|---|---|---|---|
| | Tₘₐₓ | Tₘₐₓ | Temp |
| | (° C.) | (min) | (° C.) |
| Example 25 | 1525 | 7.5 | 860 |
| Example 26 | 1525 | 7.5 | 650 |
| Example G | 1525 | 7.5 | n/a |
| Example H | 1500 | 7.5 | n/a |
| Example I | 1450 | 7.5 | n/a |
| Example J | 1400 | 7.5 | n/a |
| Example K | 1350 | 7.5 | n/a |
| Example L | 1525 | 7.5 | n/a |

TABLE 7
Microstructure and Ionic Conductivity (IC) of Examples 25-26 and G-L

| | Porosity | C/T | Mean Grain | IC (S/m) | IC (S/m) | IC (S/m) | IC (S/m) |
|---|---|---|---|---|---|---|---|
| | (%) | Ratio | Size (μm) | at 800° C. | at 835° C. | at 850° C. | at 900° C. |
| Example 25 | 0.15 | 0.40 | 1.11 | 7.10 | 9.19 | 10.39 | 14.80 |
| Example 26 | 0.01 | 0.29 | 1.44 | 6.79 | 8.83 | 9.73 | 13.63 |
| Example G | 0.01 | 0.11 | 1.00 | 6.51 | 8.45 | 9.41 | 13.14 |
| Example H | 0.01 | 0.10 | 0.96 | 6.44 | 8.39 | 9.35 | 13.12 |
| Example I | 0.03 | 0.08 | 0.68 | 6.32 | 8.32 | 9.32 | 13.27 |
| Example J | 0.15 | 0.08 | 0.46 | 6.14 | 8.12 | 9.10 | 13.01 |
| Example K | 1.68 | 0.07 | 0.35 | 5.81 | 7.72 | 8.68 | 12.50 |
| Example L | 0.02 | 0.11 | 1.39 | 6.47 | 8.32 | 9.22 | 12.71 |

Table 7 presents the microstructure and ionic conductivity (IC) measured for Examples 25-26 and G-L. Examples 25-26, G-I, and L have a porosity of less than 1% while Example K has a porosity greater than 1%. This indicates that low porosity can be obtained when the maximum temperature (e.g., in a single firing step) is greater than 1325° C. (e.g., 1350° C. or more). Examples 25-26 and G-L have a median grain size less than 2.5 μm, less than 2.0 μm, and less than 1.5 μm. Also, Examples 25-26 have a median grain size greater than or equal to 1.01 μm (e.g., from 1.01 μm to 2.5 μm) whereas Examples G-K have a median grain size less than or equal to 1.00 μm.

Examples G-L have a C/T ratio of 0.11 or less. In contrast, Examples 25-26 have a C/T ratio greater than or equal to 0.25, and greater than or equal to 0.27. Specifically, Example 25 has a C/T ratio of 0.40, which is the highest of the values reported in Table 7. This corresponds to an increase in the amount of the cubic phase in the stabilized zirconia (e.g., scandia-stabilized zirconia). Since Examples 25-26 having the higher C/T ratio (compared to Examples G-L), the quenching in Examples 25-26 (but present not in Examples G-L) leads to the higher C/T ratio. As discussed above, it is believed that the quenching kinetically traps (e.g., “freezes in”) the phase assemblage at the starting temperature for the quenching, which is above dashed line 1215 in FIG. 12 associated with a mixture of the cubic phase and the tetragonal phase.

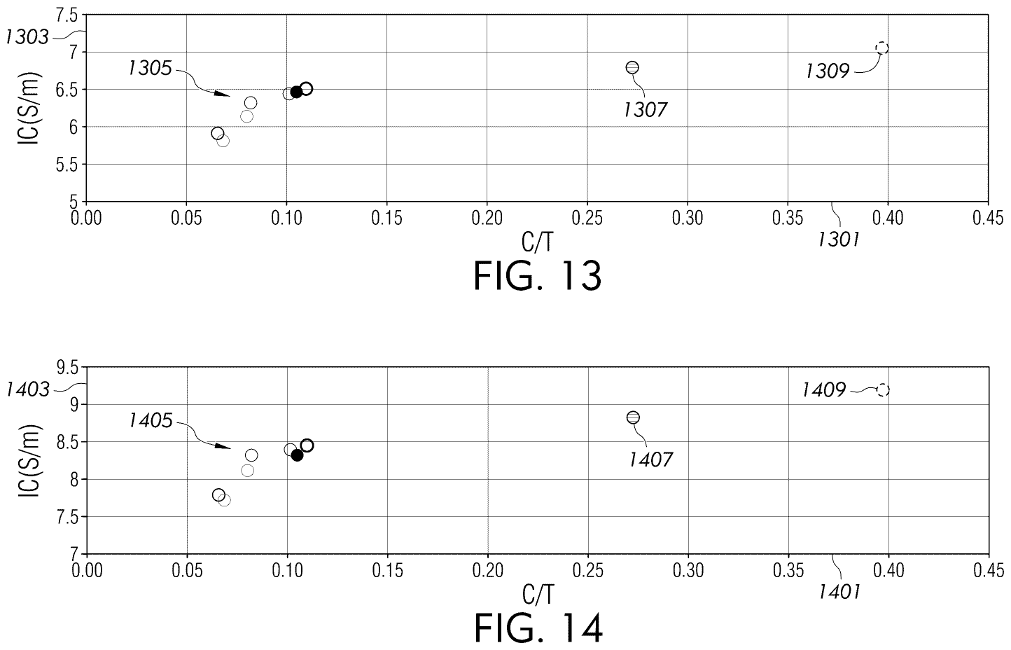

Further, the increase in C/T ratio is associated with an increase in ionic conductivity, as indicated in Table 7 and FIGS. 13-14. FIGS. 13-14 shows the relationship between ionic conductivity in S/m at 800° C. or 835° C., respectively, on the vertical axis 1303 or 1403 (i.e., y-axis) as a function of the C/T ratio on the horizontal axis 1301 or 1401 (i.e., x-axis). In FIGS. 13-14, points 1305 or 1405 correspond to Examples G-L, point 1307 or 1407 corresponds to Example 26, and point 1309 or 1409 corresponds to Example 25. As shown in both of FIGS. 13-14, the ionic conductivity (at 800° C. and/or at 835° C.) monotonically increases as the C/T ratio increases. In particular, at 800° C. (FIG. 13), Examples G-L (points 1305) have an ionic conductivity less than 6.6 S/m where as Examples 25-26 (points 1307 and 1309) have an ionic conductivity greater than 6.6 S/m and greater than or equal to 6.7 S/m or greater than or equal to 6.75 S/m; further, Example 26 (point 1309) has an ionic conductivity greater than or equal to 6.8 S/m, 6.9 S/m, and 7.0 S/m. Likewise, at 835° C. (FIG. 14), Examples G-L (points 1405) have an ionic conductivity less than 8.5 S/m where as Examples 25-26 (points 1407 and 1409) have an ionic conductivity greater than 8.5 S/m and greater than or equal to 8.6 S/m, 8.7 S/m, and 8/8 S/m; further, Example 26 (point 1409) has an ionic conductivity greater than or equal to 9.0 S/m and 9.1 S/m.

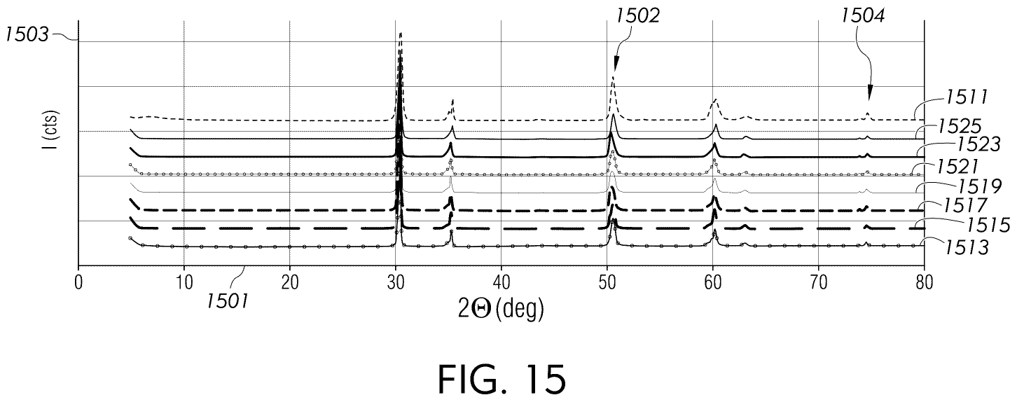

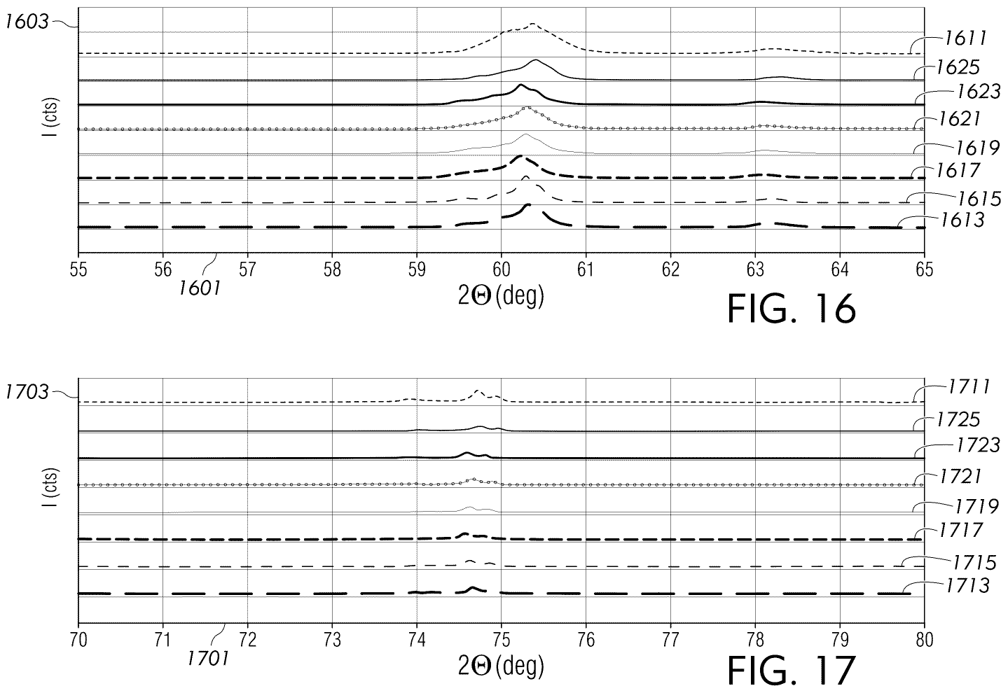

As discussed below, the C/T ratio is based on analysis of the peak(s) near 60° (scattering angle corresponding to the double angle of the incident angle) in the XRD spectra. FIGS. 15-17 show XRD spectra for Examples 25-26 and G-L. FIGS. 15-17 present the intensity of the scattering (based on the number of counts (cts)) on the vertical axis 1503, 1603, or 1703 (i.e., y-axis) as a function of the double angle (2θ) in degrees (deg) on the horizonal axis 1501, 1601, or 1701 (i.e., x-axis). Curves 1511, 1611, and 1711 correspond to Example 25; curves 1513, 1613, and 1713 correspond to Example 26; curves 1525, 1625, and 1725 correspond to Example G; curves 1523, 1623, and 1723 correspond to Example H; curves 1521, 1621, and 1721 correspond to Example I; curves 1519, 1619, and 1719 correspond to Example J; curves 1517, 1617, and 1717 correspond to Example K; and curves 1515, 1615, and 1715 correspond to Example L. FIG. 15 shows the full spectra for each of Examples 25-26 and G-L (vertically offset for readability) while FIGS. 16-17 show enlarged portions 1502 or 1504 of the spectra-namely, from 55° to 65° in FIG. 16 and from 70° to 80° in FIG. 17. As discussed above in FIG. 10, the cubic phase corresponds to a shoulder around 60° (in FIGS. 15-16) while the tetragonal phase generates the large peak slightly greater than 60° and a less intense peak slightly less than 60°. In FIG. 16, the shoulder associated with the cubic phase is the strongest in curve 1611 followed by curve 1613. In comparison, the shoulder associated with the cubic phase is much less pronounced in curves 1617, 1619, and 1621 (among others). The smaller scattering observed closer to 59° is believed to be associated with the t′ tetragonal phase.

Additionally, the effect of sintering conditions of a full solid oxide electrolyzer cell (SOEC) is demonstrated by the following comparision. The initially sintered ribbon of Example 25 (ionic conductivity of 7.1 S/m at 800° C.) was used for both SOECs. The structure of the SOEC here contained: a 20 μm thick hydrogen electrode of NiO-GDC (10 mol % gadolinium doped ceria); the sintered ribbon of Example 25 as the solid-state electrolyte; a 3 μm thick barrier layer of GDC, and a 30 μm thick oxygen electrode of strontium-doped lanthanum manganite-yttria-stabilized zirconia (LSM-YSZ). For sintering of each of these layers on the solid-state electrolyte, solid-state electrolyte was subjected to sequential sintering at 1400° C., 1350° C., and 1150° C. corresponding to sintering of the hydrogen electrode, the barrier, and the oxygen electrode, respectively. In one condition, the solid-state electrolyte (of Example 25) was batch sintered. In other condition, the solid-state electrolyte (of Example 25) was sintered in a roll-to-roll process. For the batch sintering process, the ionic conductivity (at 800° C.) of the solid-state electrolyte dropped to 6.1 S/m. In contrast, for the roll-to-roll sintering process, the ionic conductivity (at 800° C.) of the solid-state electrolyte was 6.9 S/m. Consequently, fabricating and/or sintering a solid-oxide fuel cell and/or a solid oxide electrolyzer cell using a roll-to-roll process can maintain a higher ionic conductivity of the solid-state electrolyte sheet than using batch sintering. As such, in aspects, methods of making a solid-oxide fuel cell and/or a solid oxide electrolyzer cell using the solid-state electrolyte can comprise sintering one or more layers on the solid-state electrolyte in a roll-to-roll process, which has been demonstrated to preserve a higher ionic conductivity of the solid-state electrolyte than batch sintering.

The above observations can be combined to provide a solid-state electrolyte sheet, solid-oxide fuel cell, solid oxide electrolyzer cell, and methods of making the same. The solid-state electrolyte sheet can achieve high ionic conductivity (e.g., 6.7 S/m or more at 800° C., 8.8 S/m at 835° C., 9.5 S/m or more at 850° C., 13.0 S/m or more at 900° C., or 18.0 S/m or more at 950° C.) formed as a result of the methods of the present disclosure. Examples 1-26 demonstrate an unexpected benefit of increased ionic conductivity beyond that reported in the prior art under similar conditions. Without wishing to be bound by theory, it is believed that the phase assemblage (C/T ratio), closed porosity, small average grain size, small maximum grain size, and/or low porosity contribute to the unexpectedly high ionic conductivity. Without wishing to be bound by theory, it is believed that providing a low average grain size (e.g., from 0.1 μm to 2.5 μm or from 0.1 μm to 1.5 μm) can increase the ionic conductivity, for example, by decreasing a path length along grain boundaries that could be travelled by ion transported through the solid-state electrolyte sheet. Without wishing to be bound by theory, it is believed that by limiting a maximum grain size, the ionic conductivity can be increased, for example, by decreasing a path length along grain boundaries that could be travelled by ion transported through the solid-state electrolyte sheet and/or by providing additional grain boundary per volume of the solid-state electrolyte. Providing a majority of pores as closed pores can enable an increased ionic conductivity. Also, providing a majority of pores as closed pores can facilitate longevity of the resulting solid oxide fuel cell and/or solid oxide electrolyzer cell, for example, by reducing an incidence of short circuiting the cell through the solid state electrolyte sheet (e.g., in the case of an open pore providing a path from the first major surface to the second major surface).

Further, methods of the present disclosure heat then quench to kinetically trap (e.g., “freeze in”) a phase assemblage. As discussed herein, the inventors unexpectedly discovered that quenching (e.g., from a temperature of 500° C. or more, from a temperature in a range from 600° C. to 1000° C.) can impact the resulting crystal structure(s) of the resulting solid-state electrolyte sheet and provide unexpectedly improved ionic conductivity. Consequently, it has been unexpectedly observed that increasing the amount of cubic phase in the stabilized zirconia grains can increase ionic conductivity. Without wishing to be bound by theory, it is believed that quenching from at least 500° C. can increase an amount of a cubic phase in the stabilized zirconia grains of the solid-state electrolyte sheet. The present inventors believe that it has not been appreciated that that the phase structure at a high temperatures can be largely maintained (e.g., “locked in”) by quenching from the high temperature to a temperature near room temperature (e.g., less than 100° C., from 0° C. to 40° C.).

Methods of the present disclosure can enable the formation of long ribbons of the solid-state electrolyte sheet. Firing a green tape to form the solid-state electrolyte sheet can comprise a single firing step or a plurality of firing steps. The one or more firing steps can comprise heating at a maximum temperature of 1650° C. or less (or 1625° C. or less or 1600° C. or less), which can facilitate formation of the microstructure (e.g., grain size, porosity, and/or associated grain size distribution) associated with the increased ionic conductivity of the solid-state electrolyte sheets of the present disclosure. Heating the green tape (at temperatures of 600° C. or more) for 90 minutes or less (e.g., from 5 minutes to 60 minutes) can reduce resource requirements and/or increase a throughput of the method. Also, a maximum period of time at the maximum temperature of from 10 seconds to 20 minutes or from 5% to 20% of the period of time in the firing step at temperatures of 600° C. or more can reduce resource requirements (e.g., energy) of the method. Further, the methods of the present disclosure can achieve stabilized zirconia having substantial portions of grains in the cubic phase (e.g., corresponding to point 1226 in the t+c region 1213) since the cubic phase is kinetically trapped. As demonstrated by the examples here, quenching the sintered tapes (after the heating of the green tape) as part of the firing process unexpectedly increases the presence of the cubic phase (i.e., increases the C/T ratio to greater than or equal 0.10) and unexpectedly increases the ionic conductivity of resulting solid-state electrolyte sheet.

What is claimed is:

1. A solid-state electrolyte sheet comprising:
stabilized zirconia grains comprising from 3 mol % to 12 mol % of a dopant selected from a group consisting of alumina, cerium oxide, gadolinium oxide, scandia, yttria, ytterbia, and combinations thereof;
a thickness in a range from 10 micrometers to 300 micrometers; and
an ionic conductivity at 800° C. of 6.79 S/m or more.

2. The solid-state electrolyte sheet of claim 1, wherein the ionic conductivity at 835° C. of 8.8 S/m or more.

3. The solid-state electrolyte sheet of claim 1, wherein the stabilized zirconia grains comprise a mixture of a cubic phase and a tetragonal phase.

4. The solid-state electrolyte sheet of claim 1, wherein the stabilized zirconia grains exhibit a ratio of a cubic phase to a tetragonal phase (C/T ratio) of 0.12 or more.

5. The solid-state electrolyte sheet of claim 4, wherein the C/T ratio is from 0.27 to 0.50.

6. The solid-state electrolyte sheet of claim 1, wherein the ionic conductivity at 800° C. is 7.00 S/m or more, or the ionic conductivity at 835° C. is 9.0 S/m or more.

7. The solid-state electrolyte sheet of claim 1, wherein a majority of pores in the solid-state electrolyte sheet is a closed porosity, and the solid-state electrolyte sheet comprises a porosity of 1.0% or less.

8. The solid-state electrolyte sheet of claim 1, wherein the stabilized zirconia grains comprise from 3 mol % to about 6 mol % of the dopant, and the dopant comprises scandia.

9. The solid-state electrolyte sheet of claim 1, wherein an average grain size of the stabilized zirconia grains is from 0.3 μm to 2.5 μm.

10. The solid-state electrolyte sheet of claim 1, wherein an average grain size of the stabilized zirconia grains is from 1.01 μm to 2.5 μm.

11. A solid oxide fuel cell comprising:
the solid-state electrolyte sheet of claim 1 comprising a first major surface and a second major surface with the thickness defined therebetween;
an oxygen electrode disposed on the first major surface; and
a fuel electrode disposed on the second major surface.

12. A solid-state electrolyte sheet comprising:
stabilized zirconia grains comprising from about 3 mol % to about 12 mol % of a dopant selected from a group consisting of alumina, cerium oxide, gadolinium oxide, scandia, yttria, ytterbia, and combinations thereof;
a thickness in a range from about 10 micrometers to about 300 micrometers;
an ionic conductivity at 800° C. of 6.79 S/m or more; and
an ionic conductivity at 835° C. of 8.8 S/m or more,
wherein the stabilized zirconia grains exhibit a ratio of a cubic phase to a tetragonal phase (C/T ratio) from 0.15 to 0.50.

13. The solid-state electrolyte sheet of claim 12, wherein the C/T ratio is from 0.27 to 0.50.

14. The solid-state electrolyte sheet of claim 12, wherein:
the ionic conductivity at 800° C. is 7.00 S/m or more; or
the ionic conductivity at 835° C. is 9.0 S/m or more.

15. A method of making a solid-state electrolyte sheet comprising:
casting a green tape comprising stabilized zirconia comprising from 3 mol % to 12 mol % of a dopant selected from a group consisting of alumina, cerium oxide, gadolinium oxide, scandia, yttria, ytterbia, and combinations thereof;
firing the green tape to form the solid-state electrolyte sheet, wherein the firing comprises:
heating the green tape at temperatures of 600° C. or more for 90 minutes or less with a maximum temperature of 1650° C. or less to form a sintered tape; and
quenching the sintered tape from a temperature of from a starting temperature of 500° C. or more to final temperature of less than 100° C.

16. The method of claim 15, wherein the starting temperature for the quenching is from 600° C. to 1000° C., and the solid-state electrolyte sheet comprises stabilized zirconia grains comprise a mixture of a cubic phase and a tetragonal phase.

17. The method of claim 15, wherein the stabilized zirconia grains in the solid-state electrolyte sheet exhibit a ratio of a cubic phase to a tetragonal phase (C/T ratio) is 0.12 or more, and an average grain size of the stabilized zirconia grains is from 0.3 μm to 2.5 μm.

18. The method of claim 15, wherein a thickness of the solid-state electrolyte sheet is in a range from 10 micrometers to 300 micrometers, and a cubic phase is the predominant crystal phase in the stabilized zirconia grains, and a majority of pores in the solid-state electrolyte sheet is a closed porosity, and the solid-state electrolyte sheet comprises a porosity of 1% or less.

19. The method of claim 15, wherein the dopant comprises scandia, the stabilized zirconia grains comprise from 3 mol % to about 6 mol % of the dopant, and the stabilized zirconia grains are free of at least one of alumina, yttria, a lanthanoid oxide, or combinations thereof.

20. The method of claim 15, wherein the green tape, as a wt % of the green tape, comprises:
from 55 wt % to 70 wt % of the stabilized zirconia;
from 15 wt % to 25 wt % of a solvent;
from 10 wt % to 15 wt % of a polymeric binder;
from 0.1 wt % to 5 wt % of a dispersant; and
from 0.1 wt % to 2 wt % of a protic base.
